(19) United States
(12) Patent Application Publication
(10) Pub. No.: US 2025/0145493 A1
(43) Pub. Date: May 8, 2025

(54) SYSTEMS AND METHODS FOR PREPARING ELECTRODE MATERIALS VIA AEROSOL DECOMPOSITION

(71) Applicant: Stratus Materials Inc., Pittsburgh, PA (US)

(72) Inventors: Jared Mitchell, Pittsburgh, PA (US); Jay F. Whitacre, Pittsburgh, PA (US)

(73) Assignee: Stratus Materials Inc., Pittsburgh, PA (US)

(21) Appl. No.: 18/933,762

(22) Filed: Oct. 31, 2024

Related U.S. Application Data
(60) Provisional application No. 63/596,038, filed on Nov. 3, 2023.

(51) Int. Cl. C01G 53/50

(52) U.S. Cl. CPC C01G 53/50; C01P 2002/74; C01P 2002/88; C01P 2004/03; C01P 2006/40

(57) ABSTRACT

Methods and systems for preparing electrode materials such as lithium-rich metal oxide materials, including the decomposition (e.g., via aerosol decomposition) of precursor materials, are generally provided.

### RELATED APPLICATIONS

This application claims priority under 35 U.S.C. § 119 (e) to U.S. Provisional Patent Application No. 63/596,038, filed Nov. 3, 2023, and entitled “Systems and Methods for Preparing Electrode Materials Via Aerosol Decomposition,” which is incorporated herein by reference in its entirety for all purposes.

### TECHNICAL FIELD

Methods and systems for preparing electrode materials such as lithium-rich metal oxide materials, including the decomposition of precursor materials, are generally provided.

### SUMMARY

Methods and systems for preparing electrode materials such as lithium-rich metal oxide materials, including the decomposition (e.g., via aerosol decomposition) of precursor materials, are generally provided. The subject matter of the present invention involves, in some cases, interrelated products, alternative solutions to a particular problem, and/or a plurality of different uses of one or more systems and/or articles.

In one aspect, methods (e.g., for synthesizing transition metal oxide electrode materials and/or precursors thereof) are provided. In some embodiments, the method comprises aerosolizing a precursor composition in an environment having a temperature of greater than or equal to 500° C. and less than or equal to 900° C., the precursor composition comprising particles comprising one or more metal cations and one or more anions, such that at least a portion of the one or more anions are removed, thereby forming a decomposed precursor powder, wherein the one or more metal cations are selected from the group consisting of manganese, nickel, cobalt, lithium, sodium, potassium, magnesium, calcium, aluminum, and iron. In some embodiments, the one or more anions are selected from the group consisting of carboxylate-containing anions, nitrates, and sulfates. In some embodiments, the one or more anions are selected from the group consisting of carboxylate-containing anions and nitrates.

In some embodiments, the method comprises aerosolizing a solid precursor composition in an environment having a temperature of greater than or equal to 500° C. and less than or equal to 900° C., the precursor composition comprising particles comprising one or more metal cations and one or more anions, such that at least a portion of the one or more anions are removed, thereby forming a decomposed precursor powder.

In another aspect, systems are provided. In some embodiments, the system comprises a dryer comprising an atomizer and/or spray nozzle, the dryer configured to receive a pre-drying precursor composition and produce particles from the pre-drying precursor composition to form a dried composition having less liquid than the pre-drying precursor composition and an aerosolizer configured to receive at least some of the dried composition and aerosolize the at least a some of the dried composition in an environment having a temperature of greater than or equal to 500° C. and less than or equal to 900° C. to form a decomposed precursor powder.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic block diagram of an example of a system for processing a precursor composition and producing a powder material, comprising a dryer, an aerosolizer, a furnace, and a quenching container, according to some embodiments;

FIG. 2 shows scanning electron microscopy (SEM) images of dewatered material (left) as well as the material that has undergone aerosol decomposition (ADC) (right), according to some embodiments;

FIG. 3 shows plots of particle size distribution of both material after dewatering (but before ADC) and the material after going through the ADC process, according to some embodiments;

FIG. 4 is a plot showing thermogravimetric (TGA) assessment of dewatered material that has experienced different amounts of time in the ADC environment at different temperatures and time settings, according to some embodiments;

FIG. 5 is a graph showing the indexed normalized and offset XRD patterns of LXMO active material powders made using the stated ADC process and having the formula: Li[NiₓLi(_{1/3-2x/3})Mn_{(2/3-x/3)}]O₂, where the nickel content, x=0.25, according to some embodiments; and

FIG. 6 and FIG. 7 are plots of representative electrochemical data from the LXMO materials produced using the ADC process as described in the first processing procedure 1 or the second processing procedure 2, according to some embodiments.

### DETAILED DESCRIPTION

Methods and systems for preparing electrode materials such as lithium-rich metal oxide materials, including the decomposition (e.g., via aerosol decomposition) of precursor materials and their byproducts, are generally provided.

In some aspects, this disclosure describes methodologies, systems, and apparatuses for generating materials such as electrode active materials (e.g., lithium ion battery cathode active materials). Starting materials may be combined to form a pre-drying precursor composition (e.g., a solution/gel that may or may not include lithium). The pre-drying precursor composition may be subjected to a step in which a liquid (e.g., water) is removed (e.g., the composition may be partially or completely dewatered). As a result, in some embodiments, a nominally homogeneous powder may be produced as a precursor composition. In some embodiments, the precursor composition may be aerosolized (e.g., by being introduced into a fluidized bed environment) wherein the particles may at least partially decompose (e.g., in some embodiments without agglomerating). In some such embodiments, the particles are mixed with other materials as needed and thermally processed to form a finished powder material (e.g., a highly crystalline finished powder material). In some instances, the resulting finished powder material may be inserted into a lithium-ion battery as a cathode material.

The need for more energy dense batteries that can provide power to electric vehicles (amongst other electrically-powered devices) generally continues to increase. For example, electric vehicles can reduce local air pollution as they do not have internal combustion engines. However, historically, expensive and complicated manufacturing processes continue to contribute to the high cost of lithium-containing materials commonly used in Li-ion batteries and the Li-ion batteries. The cathode material is generally the highest cost of all battery constituents, and so any process or materials innovation that reduces this cost is of significant value.

Li-ion batteries generally contain a negative electrode, positive electrode (the cathode), and an ionically conducting electrolyte (e.g., fluid) electronically separating the anode and the cathode. When charged, Li-ions (Li⁺) may be drawn from the cathode through the electrolyte and insert themselves within the anode. Silicon, graphite and other metals/alloys can be used as an intercalation compound for the anode. A solution of organic solvents including a lithium salt or Li-ion conducting polymer can be used as the electrolyte, in some embodiments.

In some embodiments of Li-ion batteries, reversible insertion reaction compounds containing lithium transition metal oxide are desirable for the cathode, or positive electrode. Commonly used materials include, but are not limited to LiNi_{0.8}Co_{0.2}O₂, LiCoO₂, LiNiₓMn_{y}CO₂O₂ or LiNiₓCo_{y}Al₂O₂. Specifically with respect to LiNiₓMn_{y}Co_{z}O₂, varying the content ratio of manganese, nickel, and cobalt can tune the power and energy performance of a battery.

Another promising class of cathode materials are known as “Lithium-Rich”, where the material contains Li atoms in the transition metal atom positions in the crystal structure, and where the material as made can display characteristics of two different crystalline phases. These are known as LRMO (for “Lithium-rich metal oxide” materials, where the metals are commonly Mn, Ni, etc.) Some LRMO materials are manganese-rich LRMO and contains little to no cobalt (for both cost and environmental reasons) Various embodiments of the present disclosure provide a method of quickly and inexpensively producing crystallographically stable and highly durable variant of the layered lithium-rich nickel manganese oxides (“LRMO”). Additional details of some LRMO materials are described below.

Some embodiments relate to methods for generating particles (e.g., lithium-containing particles) and for electrode active materials (e.g., tailoring Li-ion battery active cathode materials). In some embodiments, the method includes combining starting materials to form a fully dissolved chemically homogeneous pre-drying precursor solution, and from this, producing a dry/dewatered powder of the material with controlled size. This could be done using a spray dry process or by milling/machining/crushing sifting material that has been dewatered in a static heat environment. In some embodiments, this material is then decomposed such that all/most of the anion species present in the dewatered powder are shed. In some such embodiments, the decomposition occurs without resulting in any agglomeration or growth in particle size, and may result in a Li-metal-oxide material that is ready for subsequent thermal processing (e.g., thermal firing at over 600° C. (or over 800° C.) and, in some embodiments, ultra rapid quenching).

Some embodiments comprise combining starting materials and the stated process above to form a homogeneous precursor solution that does not contain lithium and then generating a dry/dewatered powder of the material which is then mixed with Li precursor material and thermally processed to make the desired crystalline cathode material.

In some embodiments, the method comprises collecting lithium-containing particles. The collecting may include quenching the lithium-containing particles at the end of thermal processing in a manner wherein the material is quenched in a fashion such that it is cooled from processing temperature to quench bath temperature in under 0.5 seconds.

In some embodiments, the method comprises removing liquid from the pre-drying precursor composition at least in part by spray drying and controlling the size of the droplets of the homogeneous precursor solution during spray drying by altering the type of nozzle/liquid aerosol producing method.

In some embodiments, the method comprises controlling the residence time of the droplets within the spray dry and/or aerosol decomposition environment by controlling gas flow patterns, and/or tube length.

In some embodiments, the pre-drying precursor composition includes an aqueous solution of transition metal nitrates, sulfates, acetates, citrates, formates, propionates, butyrates, other higher order aliphatic carboxylates such as pentanoates or hexanoates, and/or aromatic carboxylates (e.g., benzoates) (among other possible types of carboxyl based materials). In some embodiments, the pre-drying precursor composition includes an aqueous solution of transition metal acetates or nitrates (among other possible types of carboxyl based materials).

In some embodiments, the method comprises performing the aerosol decomposition steps in gas environments with controlled amounts of oxygen and other possible combustible species that might add needed exothermic input to the process.

In some embodiments, the method comprises generating droplets with controlled size during the spray drying step by generating two or more streams of droplets having different diameters.

In some embodiments, the method comprises controlling the chemical composition of the materials by calculating stoichiometric proportions of the starting materials based on the desired chemical composition of the lithium ion particles. In some embodiments, the method comprises making traditional cathode materials such as LiNiₓMn_{y}CO₂O₂ (where x=0, y=0, z=0, and x+y+z=1) and/or LiNiₓCo_{y}Al₂O₂ (where x=^{˜}0.8, y=^{˜}0.15, z=^{˜}0.05) positive cathode powders.

In some embodiments, the method comprises making cobalt-free, lithium rich lithium ion battery cathode materials Liₓ(Mn_{y}Ni_{1-y})₂₋ₓO₂, wherein x is greater than 1.05 and less than 1.25, and y is less than or equal to 0.95 and greater than or equal to 0.1 and the amount of oxygen can vary slightly around the perfectly stated chemical ratio of 2.

In some embodiments, the method comprises making cobalt-free, lithium-rich crystal structure lithium ion battery cathode materials using this approach that have most or all of the excess lithium replaced by one or more other alkali atoms (such as sodium) and have the formula LiₓNa_{z}(Mn_{y}Ni_{1-y})₂₋ₓO₂, wherein x+z is greater than 1.05 and less than 1.25, x is 1.0 or more, and y is less than or equal to 0.95 and greater than or equal to 0.1 and the amount of oxygen can vary slightly around the perfectly stated chemical ratio of 2. In this case, another alkali such as potassium could also be substituted with or instead of sodium.

The methods and systems of this disclosure may, in some embodiments, realize any of a variety of advantages. For example, certain existing solvated gel-based processing methods commonly have a long-duration (hours-long) static dewatering/decomposition processing route that results in materials that are inhomogeneous, take a long time to process, and have little consistency in terms of need to have their particle morphology. In some embodiments, by using this combined liquid removal (e.g., spray drying) and aerosol thermal decomposition approach, homogeneous fully dewatered/decomposed precursor material may be produced in a manner of minutes. In some embodiments, particle size and particle size distribution can be controlled by altering spray dryer and aerosol decomposition (ADC) step settings, including the use of different solution aeration approaches (for example but not limited to using rotary atomization, typical spray nozzles, electrostatic atomization, or ultrasonic atomization. In some embodiments, the processing time is reduced from hours to minutes. In some embodiments, thermal efficiency is increased and/or controlled by decoupling liquid removal (e.g., dewatering) with the decomposition step in two different environments. In some embodiments, the methods of this disclosure provide for the production of lithium-containing particles that are produced without generating significant amounts of harmful or toxic byproducts. In some embodiments, the methods of this disclosure promote versatility in terms of composition and particle size/morphology without the need to change overall system equipment.

One aspect of this disclosure generally relates to methods for synthesizing transition metal oxide electrode materials and/or precursors thereof. In some embodiments, the method comprises aerosolizing a precursor composition. The precursor comprises solid particles (e.g., an at least partially dried powder of particles), in some embodiments. In some embodiments, the step of aerosolizing involves forming a suspension of some or all of the precursor composition as particles and/or droplets in a gas (e.g., air).

In some embodiments, the precursor composition is aerosolized in an environment having a temperature sufficiently high to at least partially (or completely) decompose the aerosolized precursor composition (but in some embodiments, the environment may have a temperature not so high as to cause undesired thermal processing at the aerosolization stage of the process). In some embodiments, the precursor composition is aerosolized in an environment having a temperature of greater than or equal to 500° C., greater than or equal to 550° C., greater than or equal to 600° C., greater than or equal to 650° C. In some embodiments, the precursor composition is aerosolized in an environment having a temperature of less than or equal to 900° C., less than or equal to 850° C., less than or equal to 800° C., less than or equal to 750° C., less than or equal to 700° C., or less. Combinations of these ranges are possible. Other ranges are also possible.

In some embodiments, the precursor composition comprises particles comprising one or more metal cations. In some embodiments, the one or more metal cations are selected from the group consisting of manganese, nickel, cobalt, lithium, sodium, potassium, magnesium, calcium, aluminum, and iron. It should be understood that other metal cations may also be present, although in some embodiments all of the metal cations are selected from the group consisting of manganese, nickel, cobalt (e.g., Co²⁺), lithium, sodium, potassium, magnesium, calcium, aluminum, and iron (e.g., Fe²⁺ and/or Fe³⁺). In some embodiments, at least some of the one or more metal cations are Lit. In some embodiments, at least at least some of the metal cations comprise manganese and/or nickel. In some embodiments, at least at least some of the metal cations comprise manganese and at least some of the metal cations comprise nickel. In some embodiments, at least at least some of the metal cations comprise Mn²⁺ and/or Ni²⁺. In some embodiments, at least at least some of the metal cations comprise Mn²⁺ and at least some of the metal cations comprise Ni²⁺.

In some embodiments, the precursor composition comprises one or more anions. In some embodiments, the one or more anions are selected from the group consisting of carboxylate-containing anions, nitrates, and sulfates. The carboxylate-containing anions may include, for example, acetates, citrates, formates, propionates, butyrates, other higher order aliphatic carboxylates such as pentanoates or hexanoates, and/or aromatic carboxylates (e.g., benzoates) (among other possible types of carboxyl based materials). In some embodiments, the one or more anions are selected from the group consisting of carboxylate-containing anions and nitrates. It should be understood that other anions may also be present, although in some embodiments all of the anions are one of carboxylate-containing anions and nitrates. In some embodiments, all of the anions are one of carboxylate-containing anions, nitrates, and sulfates. In some embodiments, at least some (or all) of the one or more anions are carboxylate-containing anions. In some such embodiments, at least some of the carboxylate-containing anions are selected from the group consisting of acetate, citrate, and formate. In some embodiments, at least some (or all) of the one or more anions are nitrates. In some embodiments, at least some (or all) of the one or more anions are sulfates.

In some embodiments, the aerosolization of the precursor composition is performed such that at least a portion (e.g., greater than or equal to 50 wt %, greater than or equal to 75 wt %, greater than or equal to 90 wt %, greater than or equal to 95 wt %, greater than or equal to 98 wt %, greater than or equal to 99 wt %, greater than or equal to 99.9 wt %, or all) of the one or more anions are removed. In some embodiments, the one or more anions are removed via conversion of the anions to other species and/or loss of the atoms of the one or more anions from solid particles of the precursor composition (e.g., by formation of gas such as carbon dioxide and/or a nitrogen oxide). In some embodiments, the aerosolization (and in some embodiments the removal of the one or more anions) results in the formation of a decomposed precursor powder.

In some embodiments, prior to the aerosolization, at least some (e.g., greater than or equal to 90 wt %, greater than or equal to 95 wt %, greater than or equal to 98 wt %, greater than or equal to 99 wt %, greater than or equal to 99.9 wt %, or all) liquid from a pre-drying precursor composition is removed. The term “pre-drying” is used for convenience and refers to the composition that is subjected to the process of liquid removal (e.g., which may be considered in some embodiments to be a dewatering/dehydration/drying step) and to differentiate from the precursor composition subjected to the aerosolization process later in the method in some embodiments. The removal of the liquid from the pre-drying precursor composition may form the particles comprising metal cations and anions (e.g., particles that are present in the precursor composition subjected to the aerosolization). In some embodiments, the pre-drying precursor composition comprises a liquid and the metal cations and anions dissolved in the liquid. The liquid may comprise water. For example, water may be present in the liquid of the pre-drying precursor composition in an amount of greater than or equal to greater than or equal to 50 wt %, greater than or equal to 75 wt %, greater than or equal to 90 wt %, greater than or equal to 95 wt %, greater than or equal to 98 wt %, greater than or equal to 99 wt %, greater than or equal to 99.9 wt %, or greater (e.g., 100 wt %) versus the total mass of the liquid in the pre-drying precursor composition. Other liquids may be present in the removed liquid in addition to water or instead of water, such as alcohols or other organic liquids.

In some embodiments, the pre-drying precursor composition comprises a homogeneous solution comprising the liquid and the metal cations and anions dissolved in the solution. In some embodiments, the pre-drying precursor composition comprises a solvated gel of the metal cations and the anions. The pre-drying precursor material may comprise a gel formed via a sol-gel process. The gel may comprise a nonfluid network of material (e.g., a colloidal network or polymer network) having a relatively small yield stress and that is expanded throughout its whole volume by a fluid (e.g., a liquid such as water). A gel may contain a network formed by covalent bonds or via other mechanisms such as physical aggregation. A sol-gel process may involve converting monomers into a colloidal solution (a sol) that can serve as a precursor for a resulting gel (e.g., of discrete particles or network polymers).

In some embodiments, the process of removing at least some of the liquid from the pre-drying precursor composition comprises atomizing the pre-drying precursor composition. In some embodiments, the process of removing at least some of the liquid from the pre-drying precursor composition comprises passing the pre-drying precursor composition through a spray nozzle. In some embodiments, the process of removing at least some of the liquid from the pre-drying precursor composition comprises spray-drying the pre-drying precursor composition.

In some embodiments, the process of removing at least some of the liquid from the pre-drying precursor composition comprises generating first droplets comprising the precursor composition having a first average largest cross-sectional dimension. In some such embodiments, the process of removing at least some of the liquid from the pre-drying precursor composition comprises generating second droplets comprising the precursor composition having a second, different average largest cross-sectional dimension. In some embodiments, the second droplets have an average largest cross-sectional dimension that is greater than that of the first droplets by a factor of greater than or equal to 1.05, greater than or equal to 1.1, greater than or equal to 1.2, greater than or equal to 1.5, greater than or equal to 2, greater than or equal to 5, and/or up to 10 or greater. In this context, the average largest cross-sectional dimension of droplets refers to the arithmetic mean of the largest cross-sectional dimension of the droplets.

In some embodiments, the aerosolization of the precursor composition is performed without any substantial formation of plasma from the precursor composition. It has been determined in the context of this disclosure that an aerosolization process to decompose the precursor composition can be performed with desirable results without the need to provide a plasma-inducing stimulus. In some embodiments, the amount of the precursor composition subjected to the aerosolizing that is converted to a plasma during any step of the method is less than or equal to 1 wt %, less than or equal to 0.5 wt %, less than or equal to 0.1 wt %, less than or equal to 0.05 wt %, less than or equal to 0.01 wt %, or is zero.

In some embodiments, the decomposed precursor powder formed at least in part via the aerosolization of the precursor composition comprises a homogenous mixture of the one or more metal cations and oxygen.

In some embodiments, the decomposed precursor powder comprises particles having an average largest cross-sectional dimension that is no greater than an average largest cross-sectional dimension of the particles of the precursor composition. For example, in some embodiments, the average largest cross-sectional dimension of the decomposed precursor powder is within less than or equal to 10% of the average largest cross-sectional dimension of the particles of the precursor composition.

In some embodiments, a subsequent heating step is performed on the decomposed precursor composition, thereby forming a thermally-processed powder. The subsequent heating step may be a sintering step. Further description of sintering process in the context of certain materials (e.g., LRMO or S-LRMO materials) are described in more detail elsewhere in this disclosure. The subsequent heating step may be performed in a continuous manner with the aerosolization step (e.g., immediately following the aerosolization). However, in some embodiments, the decomposed precursor composition is collected and then later subjected to the further heating (e.g., sintering). In some embodiments, at least some (e.g., greater than or equal to 50 wt %, greater than or equal to 75 wt %, greater than or equal to 90 wt %, greater than or equal to 95 wt %, greater than or equal to 98 wt %, greater than or equal to 99 wt %, greater than or equal to 99.9 wt %, or all) of the decomposed precursor powder is heated in an environment having a temperature of greater than or equal to 600° C., greater than or equal to 650° C., greater than or equal to 700° C., greater than or equal to 750° C., greater than or equal to 800° C., greater than or equal to 850° C., greater than or equal to 900° C., or greater. In some embodiments, at least some (e.g., greater than or equal to 50 wt %, greater than or equal to 75 wt %, greater than or equal to 90 wt %, greater than or equal to 95 wt %, greater than or equal to 98 wt %, greater than or equal to 99 wt %, greater than or equal to 99.9 wt %, or all) of the decomposed precursor powder is heated in an environment having a temperature of less than or equal to 1000° C., less than or equal to 950° C., or less. Combinations of these ranges are possible. Other ranges are also possible.

In some embodiments, the thermally processed powder comprises a transition metal oxide. For example, in some embodiments, the thermally processed powder comprises a lithium transition metal oxide. In some embodiments, the lithium transition metal oxide comprises a lithium-rich metal oxide (LRMO) material. Details of the LRMO material are described below. In some embodiments, the lithium transition metal oxide comprises a substituted lithium-rich metal oxide (S-LRMO) material. Details of the S-LRMO material are described below.

In some embodiments, at least some (e.g., greater than or equal to 50 wt %, greater than or equal to 75 wt %, greater than or equal to 90 wt %, greater than or equal to 95 wt %, greater than or equal to 98 wt %, greater than or equal to 99 wt %, greater than or equal to 99.9 wt %, or all) of the thermally processed powder is crystalline. For example, at least some (e.g., greater than or equal to 50 wt %, greater than or equal to 75 wt %, greater than or equal to 90 wt %, greater than or equal to 95 wt %, greater than or equal to 98 wt %, greater than or equal to 99 wt %, greater than or equal to 99.9 wt %, or all) of the particles of the thermally processed powder may be single-crystalline. As another example, at least some (e.g., greater than or equal to 50 wt %, greater than or equal to 75 wt %, greater than or equal to 90 wt %, greater than or equal to 95 wt %, greater than or equal to 98 wt %, greater than or equal to 99 wt %, greater than or equal to 99.9 wt %, or all) of the particles of the thermally processed powder may be polycrystalline.

In some embodiments, the thermally processed powder produced by the further heating (e.g., sintering) is quenched, thereby forming a quenched powder. In some embodiments, the quenching occurs in less than or equal to 500 microseconds, less than or equal to 200 microseconds, and as little as 100 microseconds, or less. In some embodiments, the quenching comprises exposing the thermally processed powder to a quenching liquid. In some embodiments, the quenching liquid comprises water in an amount of greater than or equal to 50 wt %, greater than or equal to 75 wt %, greater than or equal to 90 wt %, greater than or equal to 95 wt %, greater than or equal to 98 wt %, greater than or equal to 99 wt %, greater than or equal to 99.9 wt %, or 100 wt % versus the weight of the quenching liquid. Additional details regarding the quenching in the context of certain materials, such as the LRMO and/or S-LRMO materials, are described elsewhere in this disclosure.

In some embodiments, the quenched powder is then incorporated into an electrode (e.g., a cathode).

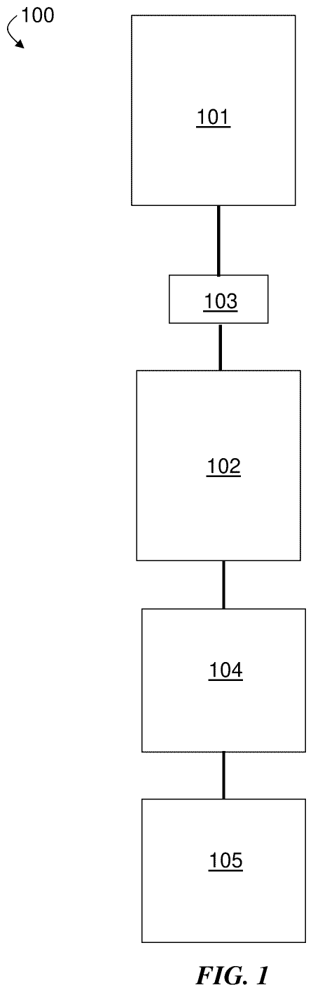

Certain aspects of this disclosure relate to systems that can, in some embodiments, perform one or more of the processing steps described. FIG. 1 shows a schematic block diagram of system 100, according to some embodiments.

In some embodiments, the system comprises a dryer. For example, FIG. 1 shows dryer 101. In some embodiments, the dryer comprises an atomizer and/or spray nozzle. In some embodiments, the dryer is configured to receive the pre-drying precursor composition and produce particles from the pre-drying precursor composition to form a dried composition having less liquid than the pre-drying precursor composition (e.g., the dryer may remove at least 90 wt %, at least 95 wt %, at least 98 wt %, at least 99 wt %, at least 99.9 wt %, or all of the liquid).

In some embodiments, the system comprises an aerosolizer. For example, system 100 may comprise aerosolizer 102. The aerosolizer may be configured to receive at least some of the dried composition. In some embodiments, the aerosolizer is configured to aerosolize the at least a some of the dried composition to. In some embodiments, the aerosolizer comprises a nebulizer. One example of a suitable nebulizer for at least some embodiments is a venturi nebulizer. In some embodiments, the aerosolizer is configured to produce an aerosol without providing a stimulus for the production of any plasma from the dried composition. In some embodiments, the aerosolizer is configured to aerosolize the at least some of the dried composition in an environment having a temperature in any of the ranges described above for the aerosolization step (e.g., in a range of greater than or equal to 500° C. and less than or equal to 900° C.). The aerosolizer may be configured to produce a decomposed precursor powder.

In some, but not necessarily all embodiments, the system comprises a collection vessel configured to contain at least a portion of the dried composition and, in some embodiments, to transport the at least a portion of the dried composition to the aerosolizer. For example, system 100 may comprise collection vessel 103, according to some embodiments.

In some, but not necessarily all embodiments, the system comprises a furnace configured to receive at least some of the decomposed precursor powder. For example, system 100 may comprise furnace 104. In some embodiments, the furnace is configured to subject the decomposed precursor powder to an elevated temperature (e.g., a temperature in any of the heating (e.g., sintering) ranges described above), thereby forming a thermally processed powder.

In some, but not necessarily all embodiments, the system comprises a quenching container. For example, system 100 may comprise quenching container 105. The quenching container may be configured to contain a quench(ing) liquid. In some embodiments, the quenching container is configured to receive at least some of the thermally processed powder into the quench liquid. In some embodiments, the quench liquid is an aqueous solution. In some embodiments, the quench liquid comprises water in an amount of greater than or equal to 90 vol %, greater than or equal to 95 vol %, or greater than or equal to 99 vol % water. In some embodiment, the quench liquid is substantively water. However, one or more of liquids may be present in the quench in addition to or instead of water. For example, the quenching liquid may comprise an oil and/or an alcohol.

In some embodiments, the methods of this disclosure are operated in a partially or completely closed loop manner. For example, in some embodiments, at least some byproducts of the process for synthesizing transition metal oxide electrode materials and/or precursors thereof may be reused as a starting material for the process and/or converted into a starting material for the process. Such a recycling of species during the method may advantageously improve efficiency and/or reduce the amount of reagents input into the synthesis, which may e.g., reduce cost and/or chemical waste.

As one example, in some embodiments, the precursor composition is a first precursor composition, the decomposed precursor powder is a first decomposed precursor powder, the one or more cations are one or more first cations, the one or more anions are one or more first anions, the pre-drying precursor composition is a first pre-drying precursor composition, the liquid is a first liquid, and the method further comprises using a byproduct of the production of the first decomposed precursor powder to produce a second decomposed precursor powder. The second decomposed precursor powder may be of the same composition as the first decomposed precursor powder or different than the first decomposed precursor powder. For example, the second decomposed precursor powder may comprise an additional amount of the first decomposed precursor powder synthesized at a later time (e.g., as a later batch or later during a continuous synthesis process).

In some embodiments, involving the reuse of a byproduct in producing a second decomposed precursor powder, species comprising or derived from the one or more first anions (e.g., removed from the first precursor composition during the aerosolization of the first precursor composition) are reused to generate a starting material. For example, the species comprising or derived from the one or more removed first anions are reused to generate a second pre-drying precursor composition. In an exemplary set of embodiments, a second pre-drying precursor composition comprising a second liquid and one or more second metal cations and one or more second anions dissolved in the second liquid is formed, with the second pre-drying precursor composition formed at least in part by exposing a species comprising the one or more second metal cations to a gaseous species formed from at least some of the one or more first anions removed during the aerosolizing the first precursor composition. In some cases, at least some of the one or more second anions in the second pre-drying precursor composition may be a reaction product resulting from the exposure of the species comprising the one or more second metal cations to the gaseous species. The species comprising the one or more second metal cations may, in some embodiments, be a solid comprising the second metal cations and/or a liquid solution comprising the one or more cations as a dissolved species.

In some embodiments, the one or more first cations are the same as the one or more second cations, while in other embodiments, at least some of the one or more first cations are different from the one or more second cations. For example, in some embodiments, the one or more first cations and the one or more second cations both comprise manganese cations and/or nickel cations. In some embodiments, the one or more first anions are the same as the one or more second anions, while in other embodiments, at least some of the one or more first anions are different from the one or more second anions. For example, in some embodiments, the one or more first anions and the one or more second anions both comprise carboxylate-containing anions, nitrates, and/or sulfates. In some embodiments, the first liquid is the same as the second liquid, while in other embodiments, at least some of the first liquid is different from the second liquid. For example, in some embodiments, the first liquid and the second liquid both are, or comprise, water.

In some embodiments, the gaseous species (e.g., formed at least in part from the one or more first anions removed during the aerosolization) comprise a vapor comprising the one or more first anions. In some embodiments, the gaseous species formed at least in part from the one or more first anions removed during the aerosolization comprise species formed by a chemical reaction undergone by the one or more first anions. As one example, in some embodiments in which the one or more first anions comprise nitrate anions, the gaseous species formed during aerosolization may comprise a NOx gas such as NO₂ formed from the nitrates (e.g., as a thermal byproduct). As another example, in some embodiments in which the one or more first anions comprise sulfate anions, the gaseous species may comprise a SOₓ gas such as SO₂ and/or SO₃ formed from the nitrates (e.g., as a thermal byproduct).

In some embodiments, the gaseous species formed from the one or more removed first anions is exposed to the species comprising the one or more metal cations. The exposure may result directly or indirectly in the formation of the second pre-drying precursor composition. In one illustrative example, NOx such as NO₂ produced by aerosolizing particles comprising manganese nitrate (the first precursor composition) may be collected and transported to a bed and/or suspension of manganese oxide (MnO₂). Without wishing to the bound by theory, the NOx and the manganese oxide may participate in one or more chemical reactions resulting in the formation of additional manganese nitrate, which may be incorporated into a gel and/or homogeneous solution constituting the second pre-drying precursor composition.

In some embodiments, the liquid removal (e.g., drying) and aerosolization processes are performed on the second pre-drying precursor composition under the same (or different) conditions as those used when treating the first pre-drying precursor composition to form the first decomposed powder. For example, in some embodiments, at least some of the second liquid is removed from the second pre-drying precursor composition, thereby forming particles comprising the one or more second metal cations and the one or more second anions. The second precursor composition may, in some embodiments, comprise such formed particles. The drying may be performed, for example, via atomization and/or passing the second pre-drying precursor composition through a spray nozzle. For example, in some embodiments, the second pre-drying precursor composition comprising a solution and/or gel comprising manganese nitrate may be spray dried to form particles comprising the manganese nitrate, constituting at least some of the second precursor composition.

The second precursor composition may be aerosolized, in some embodiments, in an environment having a temperature of greater than or equal to 500° C. (e.g., greater than or equal to 550° C., greater than or equal to 600° C., greater than or equal to 650° C.) and less than or equal to 900° C. (e.g., less than or equal to 850° C., less than or equal to 800° C., less than or equal to 750° C., less than or equal to 700° C., or less). In some embodiments, the aerosolization may be performed such that at least a portion of the one or more second anions are removed, thereby forming a second decomposed precursor powder. For example, particles comprising manganese nitrate prepared via recycled NOx may be aerosolized in such an environment, thereby forming a second decomposed powder. The second decomposed powder may be of the same composition as the first decomposed powder, or may have a different composition.

At least some of the second decomposed precursor powder may then, as above, heated in an environment having a temperature of greater than 600° C. (e.g., greater than or equal to 650° C., greater than or equal to 700° C., greater than or equal to 750° C., greater than or equal to 800° C., greater than or equal to 850° C., greater than or equal to 900° C., or greater). In some embodiments, heating may form a second thermally-processed powder. The second thermally-processed powder may be of the same composition as the first thermally-processed powder, or may have a different composition. In some embodiments, the second thermally-processed powder may be quenched to form a second quenched powder. The second quenched powder may, in some embodiments, be incorporated into an electrode (e.g., a cathode such as the cathodes comprising an electrode active material as described in more detail below). As noted above, in some instances an LRMO material is produced from the precursor composition. In some embodiments, the LRMO material has a formula Li[NiₓLi_{(1/3-2x/3)}Mn_{(2/3-x/3)}]O₂ where the nickel content, x is greater than or equal to 0 and less than or equal to 0.5, such as greater than or equal to 0.125 and less than or equal to 0.425, such as greater than or equal to 0.19 and less than or equal to 0.26. Another way to write the formula for the LLRNMO material is Li₂(Mn_{y}Ni_{1-y})_{2-z}O₂, where z is greater than or equal to 1.05 and less than or equal to 1.25, and y is greater than or equal to 0.55 and less than or equal to 0.83 (e.g., z is greater than or equal to 1.05 and less than or equal to 1.25, and y is greater than or equal to 0.55 and less than or equal to 0.83). In some embodiments, the LLRNMO material has a Li:metal oxide (Mn and Ni metal oxides) ratio of greater than or equal to 1.4 and less than or equal to 1.6. Yet another way to represent this material is by the formula y(LiMO₂·(1−y)LiMnO₃, where y is greater than or equal to 0.8 and less than or equal to 1, and M is Ni or some combination of transition metals including Ni and at least one of Al, Ti, Fe, or Cr. In some embodiments, when this class of lithium rich cathode material is produced, it exhibits either a 2 phase, a composite of 2 phases, or a solid solution structure where there is typically evidence of the co-existence of a trigonal LiMO₂ R3-m (alpha-NaFeO₂ structure) type phase and a monoclinic Li₂MO3-C2/m phase, both which have repeating layers consisting of predominately a Li layer, an oxygen layer, and a layer with transition metals (and some excess Li).

The distribution of the Ni, Mn, and Li in the transition metal sites in this structure has been found to depend on synthetic processes. Without wishing to be bound by a particular theory, it is believed in the context of this disclosure that a more uniform distribution of the Li, Mn, and Li atoms in the transition metal sites can, in some embodiments, result in a more electrochemically stable material that exhibits higher capacities, better transport kinetics, less capacity fade, and/or less loss in average voltage during discharge.

The LRMO material in pristine form (as made before it is charged for the first time), may exhibit an x-ray diffraction patterns that is consistent with two distinct phases: one being e.g., hexagonal and the second being monoclinic. The hexagonal phase is also referred to as a rhombohedral phase which has the same space group as a hexagonal phase. The materials of these embodiments of the present disclosure may demonstrate high (>200 mAh/g) specific capacities, and high functional voltage windows (e.g., greater than or equal to 2.0 and less than or equal to 4.8 V), without requiring cobalt (e.g., they can be cobalt free cathode materials or have relatively little cobalt content). In some embodiments, quenching the LRMO material in a liquid comprising water to ultra-rapidly cool the material results in a superior crystal structure for energy storage than reported previously in the literature. These two phases may co-exist within the material in distinct phase rounded regions or may exist in a layered/superlattice arrangement.

LRMO materials have a large body of literature dedicated to their structure, and electrochemical behaviors. The main drawbacks of these materials include low rate capabilities, and poor capacity retention caused by structural instability wherein the materials experience oxygen losses, and the migration of transition metal ions over the course of cycling. Several complex synthetic routes using scaffolds, dopants or surface modifications and coatings on LRMOs can help mitigate oxygen loss and thus serve to improve functionality. More recently it has been demonstrated that an O₂-type oxygen structure can prevent undesirable irreversible transition metal ion migration, thereby greatly improving capacity retention.

The production of these single-phase transition metal oxides can require time and energy consuming processing steps, such as ball milling, wet milling, sintering, washing, mixing, grinding, etc. In some cases, alkaline solutions are used in one or more initial processing steps, which can produce unwanted byproducts. The complexity of such processes contribute to the high cost of Li-ion batteries. In addition, tailoring the stoichiometry of the Li-ion battery materials may be difficult or impossible to accomplish on a large or commercial scale.

In this disclosure, solution-based input material production process are described. In some embodiments, a fully solvated pre-drying precursor solution containing metal cations and one or more anion species containing some combination of carbon, hydrogen, nitrogen, and oxygen is created, at least partially (or completely) dried, and then decomposed into metal-oxygen precursor complexes. In some embodiments, this process is performed such that all constituent atoms are intimately mixed and can become the desired crystal structure upon prolonged exposure to a high temperature (>600° C., >700° C., or >800° C.) thermal processing environment. In some embodiments, an aerosol-born decomposition process is performed. In some such embodiments, dried/dewatered precursor composition containing dried metal cations, and one or more anion species (such as acetate, nitrate, citrate, etc.) is produced to a powder form factor and subsequently thermally decomposed in a fluidized aerosol environment such that most/all of the anion species are shed, leaving only a homogeneous mixed metal oxide (that may or may not contain lithium, depending on the processing approach used).

In some, but not necessarily all embodiments, the powder input into the thermal processing system comprises a lithium-rich metal oxide (LRMO). According to various embodiments, a method of quickly and inexpensively forming a crystallographically-stable, highly durable, cobalt-free, lithium-rich metal oxide (LRMO) material is provided. In some embodiments, the LRMO material is a lithium-rich, lithium manganese nickel oxide material represented by the following general Formula 1:

Liₓ(Mn_{y}Ni_{1-y})₂₋ₓO₂, (1)

wherein x is greater than 1.0 and less than 1.25, and y is less than or equal to 0.95 and greater than or equal to 0.1, for example y may be greater than or equal to 0.5 and less than or equal to 0.8.

In some embodiments, the LRMO material may be a lithium-rich, lithium manganese nickel oxide material represented by the following Formula 2:

Li[Li_{(1/3-2x/3)}Mn_{(2/3-x/3)}Niₓ]O₂, (2)

wherein x is greater than or equal to 0.1 and less than or equal to 0.4.

The LRMO material in its pristine state (e.g., before it is charged for the first time), may have, in some embodiments, distinct hexagonal (e.g., rhombohedral) and monoclinic phases. Thus, in some embodiments, the LRMO material may also be represented by the expression: (1−x)[Li₂MnO₃]*x[LiMnₐNi₍₁₋ₐ₎O₂] instead, wherein the first part of this expression denotes the relative molar amount of the monoclinic phase (1−x), while the second part of this expression denotes the relative molar amount of the rhombohedral phase (x). In some embodiments, the molar fraction of the rhombohedral phase, “x”, is commonly in the range of greater than or equal to 0.8 and less than or equal to 0.95, while “a” is greater than or equal to 0.6 and less than or equal to 0.9. In some embodiments, the two phases may be disposed in a layered structure.

Various embodiments may provide LRMO materials that exhibit high (e.g., >240 mAh/g) specific capacities and high functional voltage windows (e.g., greater than or equal to 2.0 and less than or equal to 4.8 V), when used as an active material of a cobalt-free cathode.

According to various embodiments, methods of forming LRMO materials include rapid thermal processing and rapid (e.g., less than 10 seconds) or ultra-rapid (e.g., less than 500 milliseconds) quenching that result in a LRMO material having a superior crystal structure with a desired atomic order/disorder. These features may provide unexpectedly robust long-term stability and performance when used as a cathode active material.

Certain LRMO materials (e.g., synthesized without rapid quenching and/or quenching in water) may be unsuitable for use as a cathode active material due to having a low rate capability and/or poor capacity retention, which are believed to result from, for example, structural instability due to oxygen losses, transition metal ion migration during use, and/or possible manganese dissolution. Without wishing to be bound by any particular theory, the two most common aging mechanisms manifest as a fade in the average discharge voltage as the material slowly re-organizes into a predominant spinel structure, and loss in capacity over cycling due mechanical and/or chemical degradation of the material.

Examples of embodiments in which water quenching is performed with non-substituted LRMOs are described in U.S. Patent Application Publication No. 2023/0015455, published on Jan. 19, 2023, filed as U.S. patent application Ser. No. 17/810,722 on Jul. 5, 2022, and entitled “Lithium-Rich Nickel Manganese Oxide Battery Cathode Materials and Methods,” which is incorporated herein by reference in its entirety for all purposes. It is believed that water quenching results in vaporization in the form of bubble nucleation and dissipation, which actually increases the rate of heat transfer. As such, without wishing to be bound by theory, it is believed that water quenching should generally have a rate of heat transfer that can be approximated as two orders of magnitude greater than liquid nitrogen quenching. Further, in some cases, water and additives solvated into it (i.e., other materials that may be dissolved in the water) may both react with the high temperature LRMO as it quenches to create advantageous surface terminations and/or coatings that enhance electrochemical stability and durability when used in a lithium-ion battery. As described in more detail below, the methods, conditions, parameters, and/or processing steps described above may, in some embodiments, be applied to the substituted LRMO materials described in this disclosure.

Additionally, in many of the quench routes described in existing literature, the quenching is done on pressed sintered or partially sintered pellets of the material that are intact as larger bodies (e.g., having a width on the order of centimeters). In contrast, in some embodiments of the present disclosure, the quenching is performed on loose and/or milled powder with particles that are in shapes agglomerates that are 20 microns or less in average diameter, such as greater than or equal to 0.1 and less than or equal to 20 microns, for example, greater than or equal to 0.1 and less than or equal to 1 microns or greater than or equal to 1 and less than or equal to 20 microns, in average diameter, such that when the particles contact the quenching liquid (e.g., water) all of the material cools rapidly and at approximately the same rate. Other ranges are also possible. Each agglomerate may be composed of crystallites having an average size of greater than or equal to 25 nm and less than or equal to 500 nm, such as greater than or equal to 50 nm and less than or equal to 200 nm. Other ranges are also possible. Each crystallite may comprise a single crystal of the decomposed precursor composition such as an LRMO material. The crystallites may be partially fused together in the agglomerate or fully fused together in the agglomerate. If the crystallites are fully fused in the agglomerate (i.e., in a powder particle), then each crystallite comprises a single crystal grain of the powder particle which is separated from other single crystal grains in the same powder particle by grain boundaries. The average crystal grain size of the powder particles may be greater than or equal to 25 nm and less than or equal to 500 nm, such as greater than or equal to 50 nm and less than or equal to 200 nm. Other ranges are also possible. The agglomerates may be relatively porous, which allows the water to reach the crystallites inside the agglomerate.

In some embodiments, the material subjected to the quenching (e.g., a decomposed precursor composition such as an LRMO or an S-LRMO, described below) comprises a powder comprising particles (e.g., loose particles) having an average largest cross-sectional dimension of less than or equal to 20 microns, less than or equal to 10 microns, less or equal to 5 microns, less than or equal 2 microns, or less. In some embodiments, the material subjected to the quenching (e.g., a decomposed precursor composition such as an LRMO or an S-LRMO, described below) comprises a powder comprising particles (e.g., loose particles) having an average largest cross-sectional dimension greater than or equal to 0.1 microns, greater than or equal to 0.2 microns, greater than or equal to 0.5 microns, greater than or equal to 1 micron, or greater. Combinations of these ranges are possible, as noted above. Other ranges are also possible. In some embodiments, the material subjected to the quenching (e.g., a decomposed precursor composition such as an LRMO or an S-LRMO, described below) comprises a powder comprising particles (e.g., loose particles) comprising agglomerates of crystallites having an average largest cross-sectional dimension of greater than or equal to 25 nm, greater than or equal to 50 nm, greater than or equal to 100 nm or greater. In some embodiments, the material subjected to the quenching (e.g. a decomposed precursor composition such as an LRMO or an S-LRMO, described below) comprises a powder comprising particles (e.g., loose particles) comprising agglomerates of crystallites having an average largest cross-sectional dimension of less than or equal to 500 nm, less than or equal to 300 nm, less than or equal to 200 nm, or less. Combinations of these ranges are possible. Other ranges are also possible. The average largest cross-sectional dimensions of the particles and/or crystals may be determined by, for example transmission electron microscopy.

### Rapid and Ultra-Rapid Quenching

According to various embodiments, an electrode active material (e.g., an LRMO cathode active material) may be formed by thermally processing (e.g., sintering, calcining, and/or annealing) and quenching the decomposed precursor composition such as an LRMO material powder. In some embodiments, the thermal processing may include a high-temperature process where the decomposed precursor composition such as an LRMO material may be heated to a sintering temperature of greater than or equal to 600° C. and less than or equal to 1000° C. In particular, the thermal processing may include a high-temperature process where the LRMO material may be heated to a sintering temperature of greater than or equal to 800° C. and less than or equal to 1000° C., such as greater than or equal to from 850° C. and less than or equal to 950° C., or 900° C. Other ranges are also possible. The thermal processing may be carried out in any suitable thermal processing apparatus, such as a furnace, for example a tube furnace, muffle box furnace, rotary hearth kiln, belt furnace, etc.

According to various embodiments, the quenching process may include transferring the heated electrode active material (e.g., heated LRMO material) to a quench bath. The quench bath may be part of a quench fluid in the quenching apparatus described in this disclosure. For example, the heated powder (e.g., LRMO material) may be dropped directly into from the thermal processing apparatus into the quench bath. As described in more detail below, the methods, conditions, parameters, and/or processing steps described above may, in some embodiments, be applied to the substituted LRMO materials described in this disclosure.

In some existing methods, a heated material such as a heated LRMO material may slowly cool during transfer from the furnace. For example, the transfer process may take up to 10 seconds, during which the temperature of the material (e.g., LRMO material) may be slowly reduced. The present inventors have determined that slow cooling prior to entering the quench bath may result in undesirable changes to the crystal structure of the sintered material (e.g., sintered LRMO material). In other words, the temperature at which the sintered material (e.g., LRMO material) enters the quench bath may be important to providing a desired crystal structure. For example, slow cooling may result in a less desirable crystal structure.

According to various embodiments, the transfer process may be configured such that the sintered material (e.g., sintered LRMO material) enters the quench bath after a sintering process at a temperature of at least 600° C., at least 700° C., at least 800° C., such as a temperature of greater than or equal to 800° C. and less than or equal to 950° C., or greater than or equal to 850° C. and less than or equal to 925° C., or 900° C. For example, the transfer time from the thermal processing apparatus to the quench bath may be limited to 10 seconds or less, such as 1 seconds or less, such as less than 0.5 seconds, or 0.2 seconds or less. Thus, the sintered material (e.g., sintered LRMO material) is cooled from the thermal processing temperature (e.g., from the sintering temperature of at least 800° C., such as a temperature of greater than or equal to 800° C. and less than or equal to 950° C., or greater than or equal to 850° C. and less than or equal to 925° C., or 900° C.) in 10 seconds or less, such as less than 0.5 seconds, including 0.2 seconds or less. Other ranges are possible. Herein, an “ultra-rapid quenching process” may have a cooling time of less than 0.5 seconds, such as 0.2 seconds or less, for example greater than or equal to 0.1 and less than or equal to 0.2 seconds, and a “rapid quenching process” may have a cooling time of 10 seconds or less, such as greater than or equal to 0.5 seconds and less than or equal to 10 seconds. Other ranges are also possible.

The sintered material (e.g., sintered LRMO) powder particles may be quenched in the quench bath at an average rate of at least 50° C./second, such as at least 50° C./second and less than or equal to 10,000° C./second. For example, the sintered material (e.g., sintered LRMO) powder particles may be quenched at a rate of greater than or equal to 87.5° C./second and less than or equal to 8750° C./second, such as greater than or equal 1750° C./second, for example greater than or equal to 1750° C./second and less than or equal to 8750° C./second, including greater than or equal to 4375° C./second and less than or equal to 8750° C./second. Other ranges are also possible. Thus, the sintered material (e.g., sintered LRMO material) may be quenched from a temperature between the thermal processing temperature (e.g., sintering temperature) of at least 600° C. (e.g., at least 800° C.) to the temperature of the quench bath (e.g., room temperature water bath at 25° C.) in 10 seconds or less, such as in less than 500 milliseconds, including 400 milliseconds or less, 300 milliseconds or less, or 200 milliseconds or less. For example, the quenching may occur in a time period of and less than or equal 100 milliseconds and less than or equal to 400 milliseconds, or greater than or equal to 100 and less than or equal to 200 milliseconds. Other ranges are also possible. As described in more detail below, the methods, conditions, parameters, and/or processing steps described above may, in some embodiments, be applied to the substituted LRMO materials described in this disclosure.

In some embodiments, the material (e.g., LRMO material or S-LRMO material) is quenched from a sintering temperature (e.g., of at least 600° C. or at least 800° C., such as a temperature of greater than or equal to 800° C. and less than or equal to 1000° C., or greater than or equal to 850° C. and less than or equal to 950° C.) to a quenching temperature that is in the range of greater than or equal to 10° C., greater than or equal to 15° C., greater than or equal to 20° C. and/or less than or equal to 120° C., less than or equal to 100° C., less than or equal to 80° C., less than or equal to 60° C., less than or equal to 50° C., less than or equal to 45° C., less than or equal to 40° C., less than or equal to 35° C., less than or equal to 30° C., less than or equal to 25° C., or less. In some embodiments, the quenching temperature is room temperature (e.g., 25° C.). The quenching may occur in less than or equal to 500 milliseconds, less than or equal to 400 milliseconds, less than or equal to 300 milliseconds, less than 200 milliseconds, and/or as low as 150 milliseconds, as low as 100 milliseconds, or less. Combinations of these ranges (e.g., quenching occurring in a time period of greater than or equal to 100 milliseconds and less than or equal to 500 milliseconds, or greater than or equal to 100 milliseconds and less than or equal to 200 milliseconds) are possible. Other ranges are also possible.

In some embodiments, the quenching (e.g., within the time periods discussed above) comprises bringing at least 25 wt %, at least 50 wt %, at least 80 wt %, at least 90 wt %, at least 95 wt %, at least 98 wt %, at least 99 wt %, at least 99.9 wt %, or more (e.g., 100 wt %) of the sintered material (e.g., sintered LRMO material or sintered S-LRMO material) to thermal equilibrium (e.g., with its surrounding medium such as a quench bath) at a temperature that is within the range of greater than or equal to 10° C., greater than or equal to 15° C., greater than or equal to 20° C. and/or less than or equal to 120° C., less than or equal to 100° C., less than or equal to 80° C., less than or equal to 60° C., less than or equal to 50° C., less than or equal to 45° C., less than or equal to 40° C., less than or equal to 35° C., less than or equal to 30° C., less than or equal to 25° C., or less (e.g., room temperature, such as 25° C.). In some embodiments, the quenching comprises bringing at least 25 volume percent (vol %), at least 50 vol %, at least 80 vol %, at least 90 vol %, at least 95 vol %, at least 98 vol %, at least 99 vol %, at least 99.9 vol %, or more (e.g., 100 vol %) of the sintered material (e.g., sintered LRMO material or sintered S-LRMO material) to thermal equilibrium (e.g., with its surrounding medium such as a quench bath) at a temperature that is within the range of greater than or equal to 10° C., greater than or equal to 15° C., greater than or equal to 20° C. and/or less than or equal to 120° C., less than or equal to 100° C., less than or equal to 80° C., less than or equal to 60° C., less than or equal to 50° C., less than or equal to 45° C., less than or equal to 40° C., less than or equal to 35° C., less than or equal to 30° C., less than or equal to 25° C., or less (e.g., room temperature, such as 25° C.). Other ranges are also possible.

The quench fluid may include oil, alcohol, or water, and may optionally include an additive. For example, the quench fluid may be an oil bath, an alcohol bath, or a water bath. The quench fluid may also be referred to as a quench bath. The quench fluid or bath may comprise water in an amount of greater than or equal to 50 wt %, greater than or equal to 80 wt %, greater than or equal to 90 wt %, greater than or equal to 95 wt %, greater than or equal to 98 wt %, greater than or equal to 99 wt %, or greater (e.g., 100 wt %). Other ranges are also possible. The quench fluid or bath may include one or more additives such as at least one acid or at least one carbohydrate (e.g., urea or sugar), or a combination thereof, as described above. In some embodiments, the quench fluid or bath is basic in pH (e.g., a pH of greater than 7, greater than or equal to 8, greater than or equal to 9, greater than or equal to 10, greater than or equal to 11, greater than or equal to 12, greater than or equal to 14, or greater). In some embodiments, the quench fluid or bath includes a base as an additive, such as LiOH, NaOH, and/or KOH.

The quench bath may comprise a high heat capacity liquid solvent having a vaporization temperature of below 200° C. For example, the quench bath may comprise a solvent, such as water, an oil, and/or an alcohol. In some embodiments, the quench bath may comprise additives configured to modify the surface of the material (e.g., LRMO) material during quenching to improve long term chemical stability of the material. The additive may comprise an acid, a base, an alcohol and/or a dissolved carbon species, such as the acid, the alcohol or the carbon species (e.g., urea) dissolved in water.

For example, the quench bath may be an aqueous quenching solution that includes greater than or equal to 0.01 and less than or equal to 1.0 moles per liter, such as greater than or equal to 0.1 and less than or equal to 1.0 moles per liter, or greater than or equal to 0.5 and less than or equal to 1.0 moles per liter, of an acid additive, such as sulfuric acid, hydrochloric acid, nitric acid, oxalic acid, citric acid, acetic acid, phosphoric acid, orthophosphoric acid, lithium hydroxide, sodium hydroxide, potassium hydroxide, combinations thereof, or the like. Other ranges are also possible. The acid may be configured to stabilize the surface of the particles (e.g., LRMO particles) by reacting with and/or passivating dangling bonds and/or OH terminal groups of the particles that are being quenched in the water containing the acid additive.

In some embodiments in which the material being quenched is an LRMO material, the acid quenching may result in the formation of a spinel structure (e.g., surface layer) on the surfaces the quenched LRMO powder particles. The spinel structure may form a framework that stabilizes the particles and provides three-dimensional pathways for lithium diffusion. In particular, it is believed that the acid may result in an exchange of Li ions of the particles with H ions of the acid, and a subsequent structural transformation of the surface of the particles, resulting in the formation of the spinel surface layer.

In another embodiment, the quenching solution may include an alcohol and/or a carbohydrate additive in addition to or in place of the acid additive. For example, the alcohol may include isopropyl alcohol or another alcohol, and the carbohydrate may include urea or a sugar, such as fructose, galactose glucose, lactose, maltose, sucrose, combinations thereof, or the like. In some embodiments, the quenching solution may include greater than or equal to 0.01 and less than or equal to 1.0 moles per liter, such as greater than or equal to 0.1 and less than or equal to 1.0 mole per liter, or greater than or equal to 0.5 and less than or equal to 1.0 mole per liter, of the carbohydrate additive. Other ranges are also possible. In some embodiments, the carbohydrates form an intimate amorphous carbon coating on the surface of the particles (e.g., LRMO powder particles) during the quenching process in water containing the carbohydrate particle. Without wishing to be bound by any particular theory, carbon coating may advantageously be permeable to Li ions but may be impermeable to an electrolyte of the Li-ion battery. The carbon coating may also permit volumetric changes in the crystallites (e.g., LRMO crystallites) to occur during charging and discharging of the battery. As described in more detail below, the methods, conditions, parameters, and/or processing steps described above may, in some embodiments, be applied to the substituted LRMO materials described in this disclosure.

The rapid or ultra-rapid quenching processes may produce a quenched material (e.g., quenched LRMO material) having a crystal structure that provides unexpected robustness and electrical characteristics. Specifically, the degree of crystalline order in the quenched material (e.g., LRMO material such as lithium-rich lithium manganese nickel oxide) that is produced by the quenching processes may provide performance characteristics that are suited for use as a cathode active material of a lithium-ion battery that provides energy density and charge storage stability characteristics that are similar to that of cathodes that include cobalt-containing, high nickel-content, active materials.

The quenching processes may produce a quenched material (e.g., LRMO material) powder having a desired crystal structure and particle size. For example, the sintered material (e.g., LRMO material) being quenched may be a loose powder having an average particle size of 1 μm or less, such as an average particle size ranging of greater than or equal to 0.02 μm and less than or equal to 1 μm, or greater than or equal to 0.05 μm and less than or equal to 0.5 μm. Other ranges are also possible. The quenched material (e.g., LRMO material) may include crystal phases and/or crystallites having an average crystal size of greater than or equal to 25 nm and less than or equal to 500 nm, such as greater than or equal to 50 nm and less than or equal to 300 nm, in some embodiments. Each powder particle may comprise one crystallite or more than one crystallite. The loose sintered and quenched powder particles may be incorporated into a binder (e.g., carbon binder) to form a cathode electrode (e.g., for a Li-ion battery). Other ranges are also possible.

In some embodiments, the sintered and/or quenched material (e.g., LRMO material S-LRMO material described below) comprises a loose powder comprising particles having an average largest cross-sectional dimension of less than or equal to 1 micron, less than or equal to 0.5 microns, or less. In some embodiments, the sintered and/or quenched material (e.g., LRMO material or S-LRMO material described below) is a loose powder comprising particles having an average largest cross-sectional dimension of greater than or equal to 0.02 microns, greater than or equal to 0.05 microns, greater than or equal to 0.1 microns, greater than or equal to 0.2 microns, or greater. Combinations of these ranges (e.g., greater than or equal to 0.02 microns and less than or equal to 1 micron, or greater than or equal to 0.05 micron and less than or equal to 0.5 micron) are possible. Other ranges are also possible.

In some embodiments, the sintered and/or quenched material (e.g., LRMO material S-LRMO material described below) comprises a loose powder comprising particles having crystal phase and/or crystallites having an average largest cross-sectional dimension of less than or equal to 500 nm, less than or equal to 300 nm, less than or equal to 200 nm, or less. In some embodiments, the sintered and/or quenched material (e.g., LRMO material or S-LRMO material described below) comprises a loose powder comprising particles having crystal phase and/or crystallites having an average largest cross-sectional dimension of greater than or equal to 25 nm, greater than or equal to 50 nm, greater than or equal to 100 nm, greater than or equal to 150 nm, or greater. Combinations of these ranges (e.g., greater than or equal to 25 nm and less than or equal to 500 nm, greater than or equal to 50 nm and less than or equal to 300 nm) are possible. Other ranges are also possible.

The quenched material (e.g., LRMO material) may be dried to form an active material (e.g., an LRMO active material, such as thermally processed and quenched loose powder particles), which may have a hexagonal primary phase and a monoclinic secondary phase. Thus, the ratio of the hexagonal phase content to monoclinic phase content is greater than 1, such as at least 2, for example at least 2 and less than or equal to 20, according to some embodiments. For example, the sintered and quenched LRMO material (e.g., dried active material) may have a superlattice structure including hexagonal primary phase layers separated by interlayers of the monoclinic secondary phase. Alternatively, the sintered and quenched LRMO material may include a hexagonal phase matrix containing monoclinic phase nano-zones (i.e., areas having a width of less than a micron). Mn and Ni may be homogenously distributed within the crystal structure of the LRMO material (e.g., excess Mn, Ni and Li are homogenously and uniformly distributed on the transition metal crystal lattice sites). For example, crystalline particles of the sintered and quenched LRMO material may exhibit a uniform distribution of Mn and Ni atoms throughout the crystalline particles such that there are no regions that are Ni rich or Mn rich when imaged by high-angle annular dark-field (HAADF) energy dispersive X-ray spectrometry (EDS) (i.e., in EDS elemental maps of HAADF tunneling electron microscopy images). In one embodiment, the term “no regions that are Ni rich or Mn rich” in a crystalline particle means that there are no crystalline volumes greater than 3×3×3 nm in the crystalline particle in which there is a greater than 3% difference between ratios of Ni and Mn atoms compared to average ratios of the Ni and Mn atoms in the entire crystalline particle.

The crystal structure of the as-formed active material (e.g., LRMO material) may be changed by electrochemical cycling. For example, when the active LRMO material is included as an active material in an electrochemical cell, after a first charge/discharge cycle, the monoclinic phase may no longer be present at detectable levels. It is believed that the monoclinic phase may be consumed during Li ion insertion and/or extraction. As described in more detail below, the methods, conditions, parameters, and/or processing steps described above may, in some embodiments, be applied to the substituted LRMO materials described in this disclosure.

### Substituted LRMO Materials

In one aspect, a substituted lithium-rich metal oxide (S-LRMO) material, in which at least a portion of the lithium is substituted with sodium, potassium, calcium and/or magnesium, is provided. The S-LRMO may be produced using the processes of this disclosure, including, in some instances, an aerosol decomposition step to form a decomposed precursor composition (e.g., after a drying step in which at least some liquid is removed from a pre-drying precursor composition). According to various embodiments, cathode active materials comprise a substituted lithium-rich metal oxide (S-LRMO) material, in which at least a portion of the lithium is substituted with sodium, potassium, calcium and/or magnesium. Herein, the S-LRMO material may also be referred to as a substituted alkali/alkaline-atom rich metal oxide (ARMO) material. The S-LRMO material may have the general formula:

Li[LiₓA_{y}M_{z}]O_{b},
wherein A is at least one alkaline earth element and/or alkali element other than lithium, and (x+y) is greater than 0 and less than 0.3, y>0.05, and z=1−(x+y), M comprises manganese (Mn) and nickel (Ni), and b is greater than or equal to 1.8 and less than or equal to 2.2 depending on the net oxidation state of M.

In some embodiments, A is an alkaline earth element such as beryllium, magnesium, calcium, strontium, barium, and radium. In some embodiments, A is an alkali element other than lithium such as sodium, potassium, rubidium, cesium, and francium. In an exemplary set of embodiments, A is selected from the group consisting of Na, K, Ca, and/or Mg.

In some embodiments, the S-LRMO material has the general formula:

Li[LiₓA_{y}M_{z}]O_{b},
wherein A is at least one alkaline earth element and/or alkali element other than lithium, such as Na, K, Ca, and/or Mg, and (x+y) is greater than or equal to 0 and less than or equal to 0.3, y>0.05, and z=1−(x+y), M is a combination of transition metals and comprises at least manganese (Mn) and nickel (Ni), b is greater than or equal to 1.8 and less than or equal to 2.2 depending on the net oxidation state of M. Preferably, b=2. In one embodiment, (x+y) is greater than 0.1 and less than 0.25, such as 0.2, and y is greater than or equal to 0.05 and less than or equal to 0.15, such as greater than or equal to 0.06 and less than or equal to 0.14. In one embodiment, the material exhibits the crystallinity and phase content commonly found in lithium-rich layered metal oxides (i.e., in the non-substituted LRMO material embodiment) with no evidence of other crystalline phases. In one embodiment, the S-LRMO material in its pristine state (e.g., before it is charged for the first time), may have distinct hexagonal (e.g., rhombohedral) and monoclinic phases. In some embodiments, the two phases may be disposed in a layered structure. Those of ordinary skill in the art would understand, based upon the teachings of this specification, that the stoichiometry “O₂” in a chemical formula for the LRMO and/or S-LRMO is not intended to be limited to an exact chemical stoichiometry and that the actual elemental amount of oxygen may vary slightly (e.g., from greater than or equal to 1.9 to less than or equal to 2.1 moles of oxygen per unit mole active material) e.g., to accommodate slight variations in the average transition metal oxidation states of other components of the material (e.g., transition metal oxidation states). For example, M may comprise 50 to 80 atomic percent Mn, 20 to 50 atomic percent Ni, and greater than or equal to 0 and less than or equal to 10 atomic percent other elements including, for example, Ti, Al, Fe, Co, or any combination thereof. In various embodiments, up to 20% of the total Li content in the material may be substituted with one or more alkali elements other than Li and/or one or more alkaline earth elements. For example, greater than or equal to 0.5%, greater than or equal to 1%, greater than or equal to 2%, greater than or equal to 5%, greater than or equal to 10%, or more of the Li may be substituted with at least one of Na, K, Mg, and Ca. In some embodiments, up to 13%, up to 15%, up to 20%, or more of the Li may be substituted with at least one of Na, K, Mg, and Ca. For example, greater than or equal to 0.5% and less than or equal to 20%, such as greater than or equal to 1% and less than or equal to 15%, or greater than or equal to 2% and less than or equal to 13% of the Li may be substituted with at least one of Na, K, Mg and Ca. Thus, an atomic ratio of A to lithium in the above formula may be greater than or equal to 0.5:95.5 and less than or equal to 20:80. In other words, the ratio of A to (1+x) in the above formula may be greater than or equal to 0.5:95.5 and less than or equal to 20. Other ranges are also possible. When thermally processed as described above (e.g., sintered and rapidly quenched), the S-LRMO has a classical lithium-rich crystalline structure that exhibits some combination of trigonal (R-3m) and monoclinic (C2/m) crystal structure features, and no obvious secondary phases. In other words, S-LRMO includes both the hexagonal phase and the monoclinic phase, where the trigonal crystal system is a species of the hexagonal crystal family (i.e., genus).

In some embodiments, greater than or equal to 0.5%, greater than or equal to 1%, greater than or equal to 2%, greater than or equal to 5%, greater than or equal to 10%, or more of the Li is substituted with Na. In some embodiments, up to 13%, up to 15%, up to 20%, or more of the Li is substituted with Na. For example, greater than or equal to 0.5% and less than or equal to 20%, such as greater than or equal to 1% and less than or equal to 15%, or greater than or equal to 2% and less than or equal to 13% of the Li may be substituted with Na. Other ranges are also possible.

In some embodiments, greater than or equal to 0.5%, greater than or equal to 1%, greater than or equal to 2%, greater than or equal to 5%, greater than or equal to 10%, or more of the Li is substituted with K. In some embodiments, up to 13%, up to 15%, up to 20%, or more of the Li is substituted with K. For example, greater than or equal to 0.5% and less than or equal to 20%, such as greater than or equal to 1% and less than or equal to 15%, or greater than or equal to 2% and less than or equal to 13% of the Li may be substituted with K. Other ranges are also possible.

In some embodiments, greater than or equal to 0.5%, greater than or equal to 1%, greater than or equal to 2%, greater than or equal to 5%, greater than or equal to 10%, or more of the Li is substituted with Mg. In some embodiments, up to 13%, up to 15%, up to 20%, or more of the Li is substituted with Mg. For example, greater than or equal to 0.5% and less than or equal to 20%, such as greater than or equal to 1% and less than or equal to 15%, or greater than or equal to 2% and less than or equal to 13% of the Li may be substituted with Mg. Other ranges are also possible.

In some embodiments, greater than or equal to 0.5%, greater than or equal to 1%, greater than or equal to 2%, greater than or equal to 5%, greater than or equal to 10%, or more of the Li is substituted with Ca. In some embodiments, up to 13%, up to 15%, up to 20%, or more of the Li is substituted with Ca. For example, greater than or equal to 0.5% and less than or equal to 20%, such as greater than or equal to 1% and less than or equal to 15%, or greater than or equal to 2% and less than or equal to 13% of the Li may be substituted with Ca. Other ranges are also possible.

In some embodiments, the S-LRMO material (e.g., as a cathode active material) is represented by the formula Li[LiₑA_{f}M_{g}]Oₕ, wherein: e is less than or equal to 0.06, f is 0.14 or more, g=1−(e+f), A comprises at least one of Na, K, Ca or Mg, M comprises Mn and Ni, and h is greater than or equal to 1.8 and less than or equal to 2.2. Other ranges are also possible.

In some embodiments, cobalt is absent from the produced electrode active material (e.g., an LRMO material or an S-LRMO material) or is present in a relatively small amount. For example, in some embodiments, the atomic percentage of cobalt in the produced electrode active material (e.g., an LRMO material or an S-LRMO material) is zero or is less than or equal to 10 at %, less than or equal to 5 at %, less than or equal to 2 at %, less than or equal to 1 at %, less than or equal to 0.5 at %, less than or equal to 0.2 at %, less than or equal to 0.1 at %, less than or equal to 0.05 at %, less than or equal to 0.02 at %, less than or equal to 0.01 at %, less than or equal to 0.005 at %, less than or equal to 0.002 at %, less than or equal to 0.001 at %, or less. Other ranges are also possible.

In some embodiments, the S-LRMO (e.g., as a cathode active material) is represented by the formula Li_{1.14}Na_{0.06}Mn_{0.6}Ni_{0.2}O₂. In some embodiments, the S-LRMO (e.g., as a cathode active material) is represented by the formula Li_{1.06}Na_{0.14}Mn_{0.6}Ni_{0.2}O. In some embodiments, the S-LRMO (e.g., as a cathode active material) is represented by the formula Li_{1.015}Na_{0.155}Mn_{0.58} Ni_{0.25}O₂. In some embodiments, the S-LRMO (e.g., as a cathode active material) is represented by the formula Li_{1.013}Na_{0.157}Mn_{0.52}Ni_{0.32}O₂. In some embodiments, the S-LRMO (e.g., as a cathode active material) is represented by the formula Li_{1.06}K_{0.14}Mn_{0.6}Ni_{0.2}O₂. The S-LRMO material can be formed using methods similar to the methods described above with respect to the LRMO material. For example, the S-LRMO material may be manufactured using precursor materials formed by sol-gel, solid state, or co-precipitate methods. The precursor materials may comprise metalloorganic precursors of Li, Na, K, Ca, Mg and one or more transition metals and/or Al. For example, the metalloorganic precursors may be selected from acetates, carbonates, nitrates, sulfates, and/or hydroxides of Li, Na, K, Ca, Mg, Mn, Ni and optionally Fe, Co, Al and/or Ti. In some embodiments, the precursors include a greater than or equal to 0.01 and less than or equal to 0.20 molar fractional excess of the of the lithium, sodium, and/or potassium metalloorganic precursors. In some embodiments, the precursors may include a greater than or equal to 0.01 and less than or equal to 0.20 molar fractional excess of the of the lithium and/or sodium metalloorganic precursors. For example, the sol-gel may include a greater than or equal to 0.01 and less than or equal to 0.20 molar fractional excess of the of the lithium and/or sodium metalloorganic precursors. In some embodiments, the precursors include a greater than or equal to 0.01 and less than or equal to 0.20 molar fractional excess of the lithium and/or sodium metal hydroxide precursors. For example, the sol-gel may include a greater than or equal to 0.01 and less than or equal to 0.20 molar fractional excess of the of the lithium and/or sodium metal hydroxide precursors. Other ranges are also possible. The precursors may be mixed (e.g., with a solution comprising water) to form a mixture. The mixture of the precursors may be heated to form a gel.

The precursors (e.g., as a mixture such as a gel) may be thermally decomposed (e.g., to form the LRMO material). The precursors may be fired at temperatures of greater than or equal to 250° C. and less than or equal to 600° C., such as greater than or equal to 300° C. and less than or equal to 500° C., for a time period of greater than or equal to 2 hours and less than or equal to 8 hours, such as greater than or equal to 4 hours and less than or equal to 6 hours, to thermally decompose the precursors and form an S-LRMO material. The decomposed precursor materials may then be sintered at a sintering temperature (e.g., to form the sintered S-LRMO material). The decomposed precursor materials may then be sintered at a temperature of at least 800° C., such as a temperature of greater than or equal to 850° C. and less than or equal to 1000° C., such as greater than or equal to 900° C. and less than or equal to 950° C., for a time period of greater than or equal to 8 hours and less than or equal to 14 hours, such as greater than or equal to 9 hours and less than or equal to 12 hours, or greater than or equal to 10 hours and less than or equal to 11 hours, to form a S-LRMO material. Other ranges are also possible.

In some embodiments, the S-LRMO material is sintered at a sintering temperature. The sintering temperature may refer to the temperature of the environment in which the S-LRMO is present during the sintering (e.g., a furnace temperature). In some embodiments, the sintering temperature is at least 800° C., at least 825° C., at least 850° C., at least 875° C., at least 900° C., or greater. In some embodiments, the sintering temperature is less than or equal to 1000° C., less than or equal to 950° C., less than or equal to 925° C., or less. Combinations of these values (e.g., at least 800° C. and less than or equal to 1000° C., at least 850° C. and less than or equal to 950° C., at least 900° C. and less than or equal to 950° C.) are possible. Other ranges are also possible.

The S-LRMO material may be ultra-rapidly quenched from a quenching temperature to room temperature in a quench fluid or bath as described above, to form an S-LRMO active material. For example, the S-LRMO material may be quenched from a sintering temperature of at least 800° C., such as a temperature of greater than or equal to 800° C. and less than or equal to 1000° C., or greater than or equal to 850° C. and less than or equal to 950° C., to room temperature (e.g., 25° C.), in less than or equal to 500 milliseconds, or less than or equal to 200 milliseconds, such as in time period of greater than or equal to 100 milliseconds and less than or equal to 500 milliseconds, greater than or equal to 200 milliseconds and less than or equal to 100 milliseconds. Other ranges are also possible. In some embodiments, the quenching temperature and the sintering temperature may be the same or substantially the same temperature.

The excess alkali and/or alkaline earth metals and Ni and Mn atoms may be homogeneously and uniformly distributed throughout transition metal crystal lattice sites in the S-LRMO material, such that there are no crystalline volumes greater than 3×3×3 nm in the material, in which there is a greater than 3% difference between ratios of Ni, Mn, A, and Li atoms, where A is at least one of Na, K, Ca or Mg, as compared to average ratios of the Ni, Mn, Na, K, Ca, Mg, and Li atoms of a bulk material.

According to various embodiments, the S-LRMO materials utilize a reduced amount of Li due to the substitution of Li with less costly elements. The S-LRMO materials thereby provide a reduction in material cost, as compared to unsubstituted LRMO materials. In addition, the S-LRMO materials also provide an unexpected capacity stability, rate capability, and an unexpectedly high voltage, as compared to conventional non-substituted LRMO materials. Additionally, it has been unexpectedly observed in the context of this disclosure that relatively high amounts of lithium in the LRMO material can be substituted with different cations (e.g., alkalis and/or alkaline earth metals such as sodium, potassium, magnesium, and/or calcium to form an S-LRMO) while maintaining substantially the same crystal structure and properties as non-substituted analogs. For example, it was surprising that relatively high levels of lithium substitution (e.g., greater than 5% and up to 20%) could be obtained without observing substantial occurrences of potentially deleterious phenomena such as the formation of second crystal phases. This stands in contrast to expectations from literature, where it had previously been reported for nickel and manganese-containing lithium metal oxide electrode active materials that when Na is used to replace some of the Li, a secondary crystalline phase (Na_{0.7}MnO₂) was observed (Du, K., et al. (2013). “Sodium additive to improve rate performance of Li[Li_{0.2}Mn_{0.54}Ni_{0.13}Co_{0.13}]O₂ material for Li-ion batteries.” Journal of Power Sources, 244, 29-34). No substantial occurrence of such a secondary phase has been observed with the materials of this disclosure. Without wishing to be bound by any particular theory, it is believed that one contributing factor to the observed high level of substitution for lithium without disrupting desirable crystal and/or electrochemical properties is the use of the techniques of this disclosure (e.g., using rapid quenching such as in water).

In one embodiment, a method of forming an active material for a positive electrode of a lithium-ion battery comprises quenching a powder of the active material in water. In one embodiment, the method further comprises firing the active material powder prior to the quenching. The active material may be fired at a temperature of at least 800° C. The water may be at room temperature prior to the quenching, and the powder of the active material may be quenched at a rate of least 1750° C./second.

In one embodiment, the active material comprises layered substituted lithium-rich nickel manganese oxide. The excess Li, Ni and Mn atoms may be homogeneously and uniformly distributed throughout transition metal crystal lattice sites, such that there are no crystalline volumes greater than 3×3×3 nm in the material in which there is a greater than 3% difference between ratios of Ni, Mn and Li atoms compared to average ratios of the Ni, Mn and Li atoms of a bulk material. Particles of the powder of the active material may be in a shape of agglomerates which have an average size ranging from 0.1 μm to 20 μm, and the agglomerates of the powder of the active material are composed of crystallites having an average size ranging from 25 nm to 500 nm. The powder of the active material may comprise a composite of hexagonal and monoclinic phases after the quenching and is a combination of LiAMO₂ R-3m and (LiA)₂MnO₃ C2/m phases, where M is at least one of Ni or Mn and A is some combination of non-lithium alkali and alkaline earth elements. The powder of the active material may comprise a solid solution with a crystal structure that predominately or completely possess a C2/m symmetry. The powder of the active material may comprise a solid solution with a crystal structure that predominately or completely possess a R-3m symmetry.

In one embodiment, the quench water comprises an additive solvated therein. The water may comprise greater than or equal to 0.01 moles per liter and less than or equal to 1.0 moles per liter of the additive. In one embodiment, the additive comprises an acid, which may be selected from sulfuric acid, citric acid, acetic acid, phosphoric acid, hydrochloric acid, ammonium phosphate, or combinations thereof. In another embodiment, the additive comprises a carbohydrate, which may be selected from fructose, galactose glucose, lactose, maltose, sucrose, or a combination thereof.

In one embodiment, the active material is placed into the positive electrode of the lithium-ion battery cell which further comprises a negative electrode and an electrolyte. In this context, the positive electrode corresponds to a cathode, and the negative electrode corresponds to an anode. The active material comprises hexagonal and monoclinic phases prior to the electrochemical cycling of the battery, and the active material powder does not comprise the monoclinic phase after the electrochemical cycling.

In one embodiment, the positive material in a battery cell has a specific capacity of at least 230 mAh/g (at a C/20 charge rate) after the 50 electrochemical cycles at the discharge rate of up to C/2.

In one embodiment, a lithium-ion battery cell comprises: a negative electrode; an electrolyte; and a positive electrode comprising a layered lithium rich nickel manganese oxide active material, wherein the battery cell has a specific capacity of at least 215 mAh/g (at a C/20 rate) after the 50 electrochemical cycles at the discharge rate of up to C/2.

In one embodiment, particles of the powder of the active material are in a shape of agglomerates which have an average size of greater than or equal to 0.1 μm and less than or equal to 10 μm, and the agglomerates of the powder of the active material are composed of crystallites having an average crystal size of greater than or equal to 25 nm and less than or equal to 500 nm. Particles of the active material powder may have at least one of a spinel surface layer, a carbon coating or passivated oxygen bonds on a surface.

In some embodiments, fewer than 10% (e.g., fewer than 5%, fewer than 2%, fewer than 1%, fewer than 0.1%, or less) of the non-overlapping crystalline volumes greater than 3×3×3 nm in the material have a greater than 3% difference between ratios of Ni, Mn and alkali and/or alkaline earth metal atoms, as compared to average ratios of the Ni, Mn, Li, and alkali and/or alkaline earth metal atoms of a bulk material. Such a spatial distribution may be due to a high degree of cation disorder (e.g., due to homogeneous distribution of Li, K, Na, Ca, Mg, Ni, and/or Mn atoms). Other ranges are also possible.

In some embodiments, there are no crystalline volumes greater than 3×3×3 nm in the material in which there is a greater than 3% difference between ratios of Ni, Mn and alkali and/or alkaline earth metal atoms, as compared to average ratios of the Ni, Mn, Li, and alkali and/or alkaline earth metal atoms of a bulk material. Such a spatial distribution may be due to a high degree of cation disorder (e.g., due to homogeneous distribution of Li, K, Na, Ca, Mg, Ni, and/or Mn atoms).

In one embodiment, the included excess Li, K, Na, Ca, Mg, Ni, and/or Mn atoms are homogeneously and uniformly distributed throughout transition metal crystal lattice sites, such that there are no crystalline volumes greater than 3×3×3 nm in the material in which there is a greater than 3% difference between ratios of Ni, Mn and alkali and/or alkaline earth metal atoms, as compared to average ratios of the Ni, Mn, and Li atoms of a bulk material.

### Exemplary Process

The following process describes a non-limiting exemplary embodiment of a process of this disclosure. While this process is described for the production of a lithium-rich mixed metal oxide, it should be understood that the same or a similar process can be used for producing other materials (e.g., by using different precursor materials). In this example embodiment, a method of producing lithium mixed metal oxide ceramics comprises:
1) Starting with a clear/colored fully solvated gel of the transition metals and Li in the form of the metals in positive ionic form and a carboxylic acid anion group. Nitrogen-based anion species such as nitrates can also be used in concert with or exclusively.
2) The gel is first spray dried or otherwise dehydrated and reduced to a fine powder of lithium mixed metal carbonyl and/or nitrate. Most/all of the water that was in the solution is removed and all that remains is a powder that is a combination of carboxyl or nitric anion species and metal cations.
3) This dry powder is then nebulized and passed through a second high temperature environment (greater than 500 degrees C.), where the material then undergoes complete or partial thermal decomposition while remaining in a powder format. This second environment could run in continuous/series with the first dewatering step or could be done at a later time. Dwell times in this environment can range from seconds to minutes. In this decomposition step, some amount (or all) of the carboxyl and/or nitrate groups are released from the material, leaving behind a nominally homogeneous mixture of Li, transitional metals, and oxygen. During this step, it is possible that some degree of exothermic decomposition occurs that further accelerates the rate of decomposition.
4) The material, which has undergone the “powder aerosol decomposition (ADC)” step is then ready for subsequent thermal processing to create fully crystallized/functional mixed-metal oxide powders that are functional Li-ion cathode materials.
5) This subsequent thermal processing, which may comprise exposing the materials to temperatures in excess of 700 degrees C. for minutes or hours, may result in highly crystallized functional cathode active material.

### Additional Exemplary Embodiments

In some embodiments, a method for generating lithium-ion battery materials is provided. In some embodiments, the method comprises combining starting precursor materials to form a homogeneous solvated aqueous solution that can include lithium. In some such embodiments, the method comprises dehydrating this solution and forming it into a powder format containing homogeneously mixed dried precursor materials. In some such embodiments, the method comprises introducing these powered materials into a heated gas suspended flow environment wherein the dehydrated precursors decompose such that the majority of non-metal precursor materials are ejected. In some such embodiments, the method comprises firing the resulting material at temperatures in excess of 700° C. In some such embodiments, the method comprises forming a slurry with the lithium-containing particles to form lithium-ion battery electrodes for use in lithium ion batteries.

In some embodiments the material is rapidly quenched in a water-based quenching bath in less than 500 milliseconds at the end of the last firing step.

In some embodiments, a spray drying process is used to perform the first dehydration step, where the size and shape of the dehydrated particles depend on method of droplet production and residence time in the spray dry environment.

In some embodiments, the material undergoes a spontaneous exothermic reaction during the decomposition step that further increases the rate of decomposition while reducing the necessary energy input, and could also have some combustible gas introduced to increase the heat evolved during the ADC process.

In some embodiments, the precursors comprise transition metal acetates, formates, nitrates, sulfates, or a combination therein with either lithium acetate, lithium formate, lithium nitrate, and/or lithium sulfate. In some embodiments, the precursors comprise transition metal acetates, nitrates or a combination therein with either lithium acetate and/or lithium nitrate.

In some embodiments, extra energy is input into the decomposition reaction using direct microwave irradiation.

In some embodiments, the material created is a lithium-rich cathode materials of the general formula Li_{z}(Mn_{y}Ni_{1-y})_{2-x-z}O₂, where z is greater than or equal to 1.05 and less than or equal to 1.25, and y is less than or equal to 0.5 and greater than or equal to 0.1, and the actual amount of oxygen can vary by up to 10 atomic percent.

In some embodiments, the material created is Lithium-rich cathode materials of the general formula Li₂(NaₓMn_{y}Ni_{1-y})_{2-x-z}O₂, where z+x is greater than or equal to 1.05 and less than or equal to 1.25, z is greater than or equal to 0.01 and less than or equal to z−1, and y is less than or equal to 0.5 and greater than or equal to 0.1, and the actual amount of oxygen can vary by up to 10 atomic percent. In some embodiments, some of the Li is substituted with sodium and/or potassium.

In some embodiments, the material created is a sodium-substituted lithium-rich cathode material of the formula Li(Li_{0.015}Na_{0.155}Mn_{0.58}Ni_{0.25}) O₂, where Li, Na, Mn, and Ni stoichiometries can vary by up to 5 atomic %, and the amount of oxygen can vary by up to 10 atomic percent.

In some embodiments, the material created is a sodium-substituted Lithium-rich cathode materials of the formula Li(Li_{0.015}Na_{0.155}Mn_{0.58} Ni_{0.25}) O₂, where Li, Na, Mn, and Ni stoichiometries can vary by up to 5 atomic %, and the amount of oxygen can vary by up to 10 atomic percent.

U.S. Provisional Patent Application No. 63/596,038, filed Nov. 3, 2023, and entitled “Systems and Methods for Preparing Electrode Materials Via Aerosol Decomposition,” is incorporated herein by reference in its entirety for all purposes.

The following examples are intended to illustrate certain embodiments of the present invention, but do not exemplify the full scope of the invention.

### EXAMPLES

The following examples are intended to illustrate certain embodiments of the present invention, but do not exemplify the full scope of the invention.

### Example 1

This Example 1 describes a first processing procedure and characterization thereof.

The first processing procedure was as follows:
1. A clear gel of 4M aqueous sol of Mn/Ni/Li Acetate w/Citric Acid (pH˜5.9) was created. The gel was deep green in color and had no evidence of precipitate.
2. This liquid was spray dried using a two-fluid atomizer (co-current) w/typ. 10 micron d50-inlet/outlet temps ˜275/130° C., to create a light green, free-flowing and ultrafine powder (particle sizes under 10 microns).
3. This powder was then introduced into a venturi type nebulizer to generate aerosol of spray dried powder that was then injected into ˜650° C. airstream and kept in-flight for approximately 5 seconds, after which cyclonic powder collection was employed. The powder at this point became a darker brown to black color.
4. Sintering at 550 and 900° C. for a total of 24 hours was conducted, followed by taking the material through an ultra rapid quench step (heating it to over 900° C. and then quenching it in deionized (DI) water, with a total cooling time of less than 0.5 seconds). The resulting finished cathode powder was very dark/black in color and exhibited higher density and less followability than the in-process material.
5. The material was then made into a composite Li-ion battery electrode and tested in a half cell environment vs a lithium metal working/reference electrode. The material yielded at least 220 mAh/g at an average V of over 3.5V when charged and discharged at a C/20 rate.

The second, alternative processing procedure was as follows:
1. A clear gel of 4M aqueous sol of Mn/Ni/Li Acetate w/Citric Acid (pH˜5.9) was created. The gel was deep green in color and had no evidence of precipitate.
2. This liquid was spray dried using a two-fluid atomizer (co-current) w/typ. 10 micron d50-inlet/outlet temps˜450/200° C., to create a light green, free-flowing and ultrafine powder (particle sizes under 10 microns).
3. This powder was then introduced into a venturi type nebulizer to generate aerosol of spray dried powder that was then injected into ˜650° C. airstream and kept in-flight for approximately 5 seconds, after which cyclonic powder collection was employed. The powder at this point became a darker brown to black color.
4. Sintering at 550 and 900° C. for a total of 24 hours was conducted, followed by taking the material through an ultra rapid quench step (heating it to over 900° C. and then quenching it in DI water, with a total cooling time of less than 0.5 seconds). The resulting finished cathode powder was very dark/black in color and exhibited higher density and less flowability than the in-process material.
5. The material was then made into a composite Li-ion battery electrode and tested in a half cell environment vs a lithium metal working/reference electrode. The material yielded at least 220 mAh/g at an average V of over 3.5V when charged and discharged at a C/20 rate.

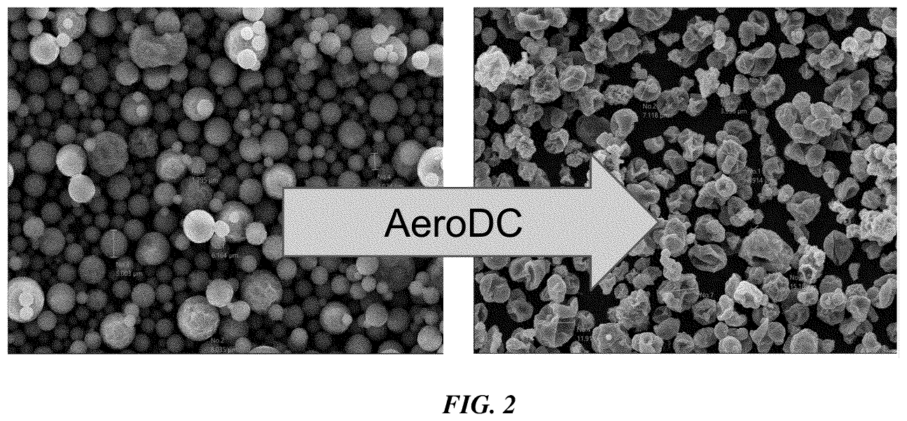

FIG. 2 shows scanning electron microscopy (SEM) images of the dewatered material (left) as well as the material that has undergone aerosol decomposition (ADC) (right). The ADC particles were less spherical, and on average were smaller and had some evidence crystalline facets evolving.

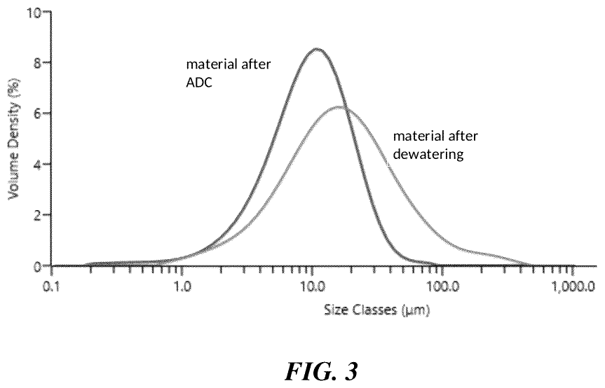

FIG. 3 shows plots of the particle size distribution of both material after dewatering (but before ADC) and the material after going through the ADC process. After ADC, the average particle size was smaller and were more uniform.

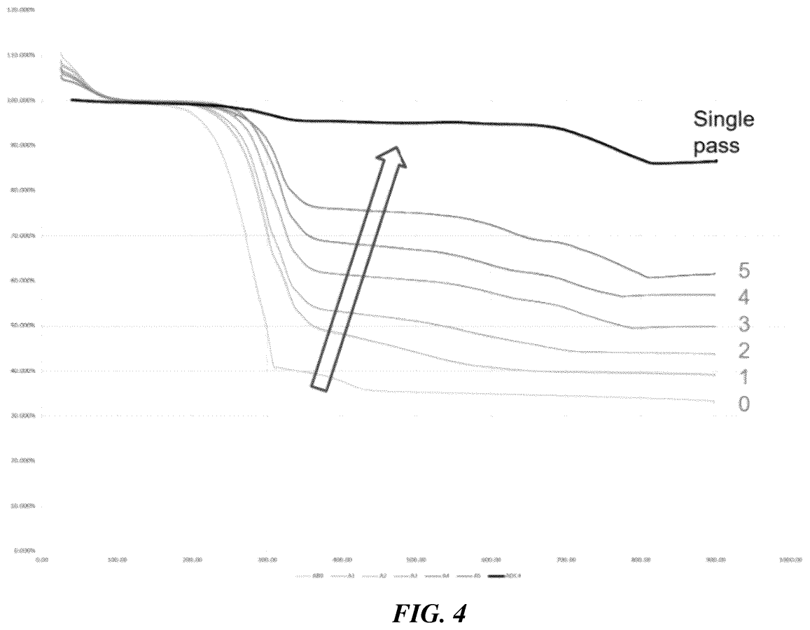

FIG. 4 is a plot showing the thermogravimetric (TGA) assessment of dewatered material that has experienced different amounts of time in the ADC environment at different temperatures and time settings. The curves labeled 0-5 are for lower temperature/time settings. The TGA data show how much mass is left to be decomposed after the ADC step, and lower mass loss is indicative of more complete decomposition. The curve labeled “single pass” is from the second processing procedure, where it was observed that nearly all of the decomposition had occurred.

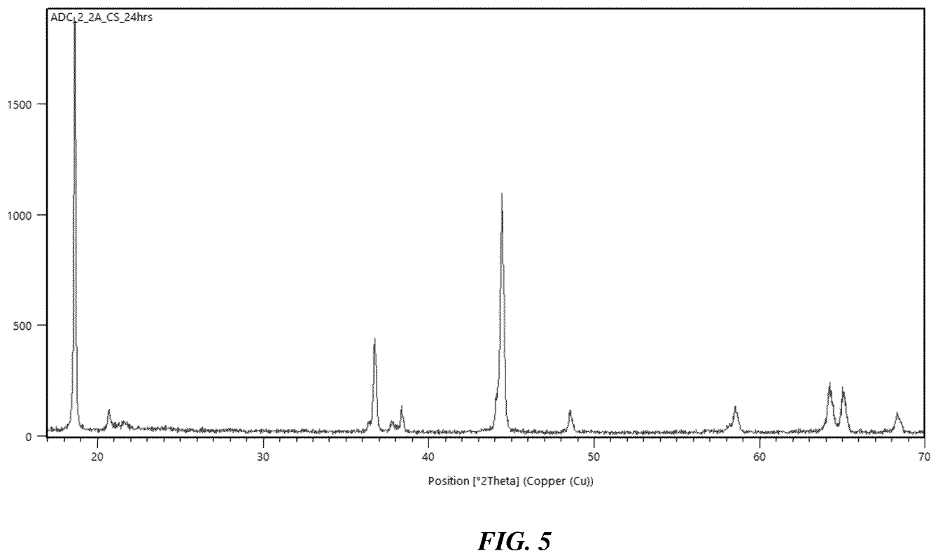

FIG. 5 is a graph showing the indexed normalized and offset XRD patterns of LXMO active material powders made using the stated ADC process and having the formula: Li[NiₓLi(_{1/3-2x/3})Mn_{(2/3-x/3)}]O₂, where the nickel content, x=0.25. This formula may also be written as Li₂(Mn_{y}Ni_{1-y})_{2-z}O₂, where z=1.16, and y=0.7.

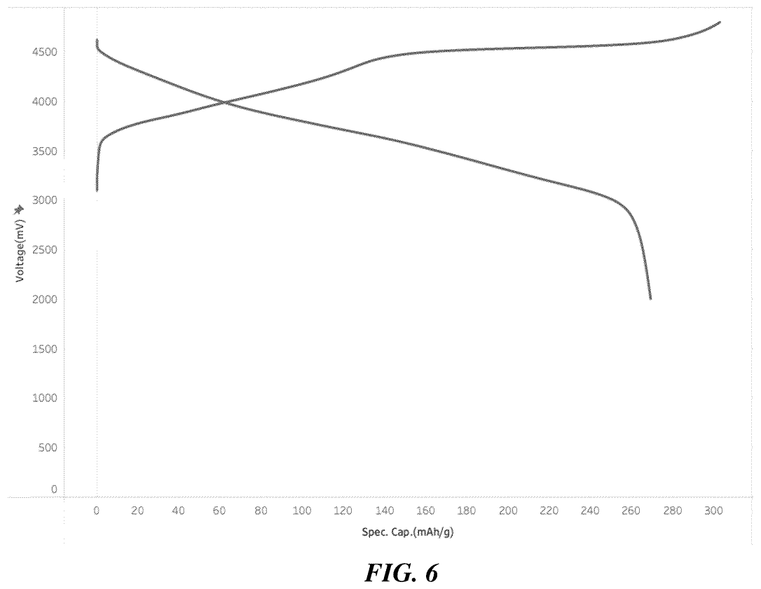

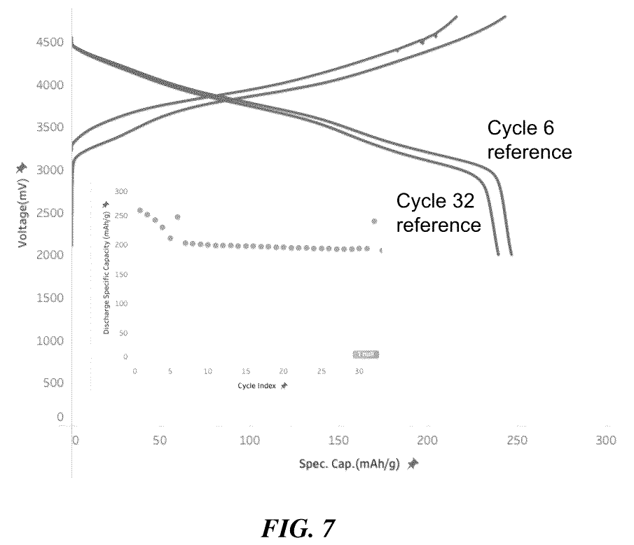

FIG. 6 and FIG. 7 are plots of representative electrochemical data from the LXMO materials produced using the ADC process as described in the first processing procedure 1 or the second processing procedure 2. As shown in FIG. 6, the material yielded a first cycle specific capacity of over 260 mAh/g and a round trip coulombic efficiency of over 80%. FIG. 7 contains cycling data showing that another example of this material is able to be repeatedly cycled without significant capacity loss.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

As used herein in the specification and in the claims, the phrase “at least a portion” means some or all, unless clearly indicated to the contrary. “At least a portion” may mean, in accordance with certain embodiments, at least 1 wt %, at least 2 wt %, at least 5 wt %, at least 10 wt %, at least 25 wt %, at least 50 wt %, at least 75 wt %, at least 90 wt %, at least 95 wt %, or at least 99 wt %, and/or, in certain embodiments, up to 100 wt %, unless clearly indicated to the contrary.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless clearly indicated to the contrary, concentrations and percentages described herein are on a mass basis.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for synthesizing transition metal oxide electrode materials and/or precursors thereof, the method comprising:
aerosolizing a precursor composition in an environment having a temperature of greater than or equal to 500° C. and less than or equal to 900° C., the precursor composition comprising particles comprising one or more metal cations and one or more anions, such that at least a portion of the one or more anions are removed, thereby forming a decomposed precursor powder
wherein the one or more metal cations are selected from the group consisting of manganese, nickel, cobalt, lithium, sodium, potassium, magnesium, calcium, aluminum, and iron.

2. The method of claim 1, wherein the one or more anions are selected from the group consisting of carboxylate-containing anions, nitrates, and sulfates.

3. The method of claim 1, wherein the one or more anions are selected from the group consisting of carboxylate-containing anions and nitrates.

4. The method of claim 1, further comprising, prior to the aerosolizing, a step of removing at least some liquid from a pre-drying precursor composition comprising a liquid and the metal cations and anions dissolved in the liquid, thereby forming the particles comprising metal cations and anions.

5. The method of claim 4, wherein the pre-drying precursor composition comprises a homogeneous solution comprising the liquid and the metal cations and anions dissolved in the solution.

6. The method of claim 4, wherein the pre-drying precursor composition comprises a solvated gel of the metal cations and the anions.

7. (canceled)

8. The method of claim 4, wherein the removing at least some of the liquid comprises atomizing the pre-drying precursor composition and/or passing the pre-drying precursor composition through a spray nozzle.

9. (canceled)

10. The method of claim 4, wherein the removing at least some of the liquid comprises generating first droplets comprising the precursor composition having a first average largest cross-sectional dimension and generating second droplets comprising the precursor composition having a second, different average largest cross-sectional dimension.

11. The method of claim 4, wherein the liquid comprises water in an amount of greater than or equal to 50 wt %.

12. The method of claim 1, wherein an amount of the precursor composition subjected to the aerosolizing that is converted to a plasma during any step of the method is less than or equal to 1 wt % or is zero.

13. The method of claim 1, wherein at least some of the one or more metal cations are Li⁺.

14. (canceled)

15. The method of claim 1, wherein at least some of the metal cations comprise Mn²⁺ and/or Ni²⁺.

16. The method of claim 1, wherein at least some of the one or more anions are carboxylate-containing anions.

17.-19. (canceled)

20. The method of claim 1, wherein at least some of the one or more anions are sulfates.

21.-22. (canceled)

23. The method of claim 1, wherein the decomposed precursor powder comprises particles have an average largest cross-sectional dimension that is no greater than the average largest cross-sectional dimension of the particles of the precursor composition.

24. The method of claim 1, further comprising heating at least some of the decomposed precursor powder in an environment having a temperature of greater than 600° C., thereby forming a thermally-processed powder.

25. (canceled)

26. The method of claim 24, wherein the thermally processed powder comprises a lithium transition metal oxide, wherein the lithium transition metal oxide comprises a lithium-rich metal oxide (LRMO) material.

27. (canceled)

28. The method of claim 26, wherein the LRMO material is represented by the formula:
Liₓ(Mn_{y}Ni_{1-y})₂₋ₓO₂,
wherein x is greater than 1.0 and less than 1.25, and y is less than or equal to 0.95 and greater than or equal to 0.1.

29. The method of claim 24, wherein the thermally processed powder comprises a lithium transition metal oxide, wherein the lithium transition metal oxide comprises a substituted lithium-rich metal oxide (S-LRMO) material.

30. The method of claim 29, wherein the S-LRMO material is represented by the formula:
Li[LiₓA_{y}M_{z}]O_{b},
wherein:
A comprises at least one of Na, K, Ca, or Mg,
(x+y) is greater than 0 and less than 0.3,
y>0.05,
$$z = 1 - ( x + y ) ,$$
M comprises Mn and Ni, and
b is greater than or equal to 1.8 and less than or equal to 2.2.

31. (canceled)

32. The method of claim 24, further comprising quenching the thermally processed powder, thereby forming a quenched powder, optionally wherein the quenching occurs in less than or equal to 500 microseconds, and optionally wherein the quenching comprises exposing the thermally processed powder to a quenching liquid.

33.-35. (canceled)

36. The method of claim 32, further comprising incorporating the quenched powder into an electrode.

37. The method of claim 4, wherein the precursor composition is a first precursor composition, the decomposed precursor powder is a first decomposed precursor powder, the one or more cations are one or more first cations, the one or more anions are one or more first anions, the pre-drying precursor composition is a first pre-drying precursor composition, the liquid is a first liquid, and the method further comprises:
forming a second pre-drying precursor composition comprising a second liquid and one or more second metal cations and one or more second anions dissolved in the second liquid, the second pre-drying precursor composition formed at least in part by exposing a species comprising the one or more second metal cations to a gaseous species formed from at least some of the one or more first anions removed during the aerosolizing the first precursor composition, wherein the one or more second anions are a reaction product resulting from the exposing the species comprising the one or more second metal cations to the gaseous species;
removing at least some of the second liquid from the second pre-drying precursor composition, thereby forming the particles comprising the one or more second metal cations and the one or more second anions; and
aerosolizing the second precursor composition in an environment having a temperature of greater than or equal to 500° C. and less than or equal to 900° C., the second precursor composition comprising the particles comprising the one or more second metal cations and the one or more second anions, such that at least a portion of the one or more second anions are removed, thereby forming a second decomposed precursor powder.

38. (canceled)

39. A system, comprising:
a dryer comprising an atomizer and/or spray nozzle, the dryer configured to receive a pre-drying precursor composition and produce particles from the pre-drying precursor composition to form a dried composition having less liquid than the pre-drying precursor composition;
an aerosolizer configured to:
receive at least some of the dried composition; and
aerosolize the at least a some of the dried composition in an environment having a temperature of greater than or equal to 500° C. and less than or equal to 900° C. to form a decomposed precursor powder.

40-42. (canceled)

43. A method, comprising:
aerosolizing a solid precursor composition in an environment having a temperature of greater than or equal to 500° C. and less than or equal to 900° C., the precursor composition comprising particles comprising one or more metal cations and one or more anions, such that at least a portion of the one or more anions are removed, thereby forming a decomposed precursor powder.
